(19) United States
(12) Patent Application Publication
(10) Pub. No.: US 2013/0066715 A1
(43) Pub. Date: Mar. 14, 2013

(54) METHODS AND SYSTEMS FOR TIME-VARIABLE CPS BASED ON USER INTERACTION WITH ADVERTISEMENT

(71) Applicant: Shigeto Umeda, Palo Alto, CA (US)

(72) Inventor: Shigeto Umeda, Palo Alto, CA (US)

(73) Assignee: Dennoo Inc., Palo Alto, CA (US)

(21) Appl. No.: 13/570,831

(22) Filed: Aug. 9, 2012

Related U.S. Application Data
(63) Continuation-in-part of application No. 13/324,325, filed on Dec. 13, 2011.
Application No. 13/324,325 is a continuation-in-part of application No. 13/477,981, filed on May 22, 2012.
Application No. 13/477,981 is a continuation-in-part of application No. 13/478,020, filed on May 22, 2012.
Application No. 13/478,020 is a continuation-in-part of application No. 13/540,528, filed on Jul. 2, 2012.
Application No. 13/540,528 is a continuation-in-part of application No. 13/540,538, filed on Jul. 2, 2012.
(60) Provisional application No. 61/540,164, filed on Sep. 28, 2011.
(60) Provisional application No. 61/568,594, filed on Dec. 8, 2011.
(60) Provisional application No. 61/600,380, filed on Feb. 17, 2012.
(60) Provisional application No. 61/615,834, filed on Mar. 26, 2012.
(60) Provisional application No. 61/635,819, filed on Apr. 19, 2012.

(30) Foreign Application Priority Data
Sep. 9, 2011 (JP) JP 2011-197718

(51) Int. Cl. G06Q 30/02

(52) U.S. Cl. 705/14.46

(57) ABSTRACT

A cost-per-second (CPS) based technology for Internet advertising is introduced. In one embodiment, the systems and methods described herein improve efficiency and efficacy of Internet based advertisements. Efficiency is improved by making advertisements relevant to the user; decreasing loss or waste in advertisement space and opportunity for the publisher; and displaying advertisements only for an appropriate duration and being charged according to actual duration for the advertiser. In embodiments, the cost for a certain branding effect can be measured and used with higher accuracy. In embodiments where multiple advertisements are shown simultaneously or at various timings, the technology introduced here provides unique bidding models to allow an advertiser to bid for advertising space, of an advertisement display. The bidding models incorporate bidding based on CPS, a function of CPS and cost-per-click, effective CPS, etc. Conversion models for comparing advertising schema using traditional and newly introduced models are also disclosed.

### CLAIM OF PRIORITY

This application claims the benefit of Japanese Patent Application No. 2011-197718, filed Sep. 9, 2011; U.S. Provisional Application Ser. Nos. 61/540,164, filed Sep. 28, 2011; 61/568,594, filed Dec. 8, 2011; 611600,380, filed Feb. 17, 2012; 61/615,834, filed Mar. 26, 2012; and 61/635,819, filed Apr. 19, 2012, and is a Continuation-in-Part of U.S. patent application Ser. No. 13/324,325 filed on Dec. 13, 2011; U.S. patent application Ser. No. 13/477,981 filed on May 22, 2012; U.S. patent application Ser. No. 13/478,020 filed on May 22, 2012; U.S. patent application Ser. No. 13/540,528 filed on Jul. 2, 2012; and U.S. patent application Ser. No. 13/540,538 filed on Jul. 2, 2012, all of which are incorporated herein by reference for all purposes in their entirety.

### FIELD

The present invention generally relates to methods and systems for processing and displaying advertisements for which the length of display can be set freely and flexibly. Such processing and displaying an advertisement may include, for example, providing a bidding platform, providing a baseline for assessing and converting costs associated with such advertising, tracking the relevancy of a displayed advertisement to a user based on the user's interaction with the displayed advertisement, etc.

### BACKGROUND

Advertising in the field of e-commerce comprises several different types and modes of advertising, such as, for example, search based advertising, branding advertising, etc. One of two main types of advertising mechanisms or e-commerce based advertisements is the “Direct Response Advertisement,” such as Cost-Per-Click (CPC) in which cost accrues for clicks, or Cost-per-Action (CPA) in which cost accrues in the event of a particular action or conversion. The other major type of e-commerce based advertisement is “branding advertisement” in which cost accrues not based on clicks, actions or effectiveness, but based on the number of “impressions,” usually in lots of one thousand impressions, or Cost-per-Mille (CPM). An online advertisement impression is a single appearance of an advertisement on a web page. Each time an advertisement loads onto a user's screen, the ad server may count that loading as one impression.

There exist other methods that are classified according to how the display space of an online page is determined, and applies to both of the abovementioned “main types” of advertisements. These types of advertisements include keyword-targeting advertisements in which advertisements that are relevant to the keywords that the user has entered into search engines are shown along with the search results, or content-matching advertisements in which advertisements that are relevant to or match the contents of the web page are shown. In addition, in terms of the shape and style of the displayed advertisements, there exist certain categories of advertisements including, for example, text advertisements where advertisements are shown in the form of text, and display advertisements where advertisements are shown in the form of images or movies. Advertisements in the form of text, banners or images are shown to the user or audience in a fixed form, and advertisements in the form of movies or videos are looped, but the underlying principle remains the same in that all such forms of advertisements are switched according to certain conditions.

Specifically, for example, in the world of internet and e-commerce, the time that an advertisement is displayed will be the time that the web pages are displayed. In other words, a single advertisement would be shown to the user (over and over again in a looped manner in the context of video based advertisements) from the moment at which the page is displayed to the user until a time at which the user takes some type of action (e.g., moving/jumping to another page, reloading/refreshing the page, etc.). The amount of time before a user moves to another page or reloads the page varies, so the amount of time for which advertisements are displayed will also vary. If the page is shown for a long period, the advertisement will also be shown for a long period.

There exists a problem that the user or users' attention towards advertisements will not sustain for long period if the advertisement is uninteresting or irrelevant to them. Whether or not the user feels that an advertisement is interesting, relevant and engaging to them will usually be determined after several seconds. In other words, if the advertisement is uninteresting to the user, the user will only watch a few seconds of the advertisement, or none of it in the worst case. On the other hand, if the advertisement is interesting to the user, the user knows that he/she is interested in the advertisement by watching a mere few seconds of it. If a single advertisement is shown to the user in the advertisement space (e.g., by being looped through the duration of the user's page visit), it is not beneficial to the user in both cases: where the advertisement matches the user's interest, or where the advertisement does not match the user's interest. This is a wasted advertising opportunity for the publisher of the page, loss in efficiency or efficacy of the advertising for the advertiser, and overall loss in realizable revenue for both the advertiser and the publisher.

In general, the billing systems for online advertisements include: (1) in the case of direct response advertisements: costs accrued for clicks; (2) in the case of branding advertisements: costs based on CPM. For example, direct response advertisements and CPC are advertisements in which cost accrues for the advertiser when the user clicks on an advertisement and progresses or shifts to a website resulting from a click of the advertisement.

In scenarios where the publisher's media has long viewing times (e.g., a lengthy newspaper article) but the click through rate (CTR) is low. The clickthrough rate of an advertisement is defined as the number of clicks on an ad divided by the number of times the ad is shown (impressions), expressed as a percentage. A low CTR would mean that when selling direct response advertisements, useless advertisements that do not generate value are shown repeatedly to the user, thus reducing the overall advertising efficacy for both the publisher and the advertiser. This results in significant loss of opportunity.

Presently, billing for advertisements is predominantly according to CPM models, especially for branding advertisements. According to the CPM model, advertisers bid (sometimes through Real Time Bidding) for certain advertisement spaces as a function of 1,000 PVs (1000 page views). That is, the bid price is set for each 1000 PV count. Such a CPM model does not take into account critical factors such as an amount of time for displaying advertisements, etc. This results in the advertisers never knowing for what period of time (total number of seconds) the advertisement had a branding effect for the user, and in effect, blindly placing advertisements based on page views without any realization or consideration for what type of a branding effect or other ROI the online advertising campaign provides.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 provides a brief, general description of a representative environment in which the invention can be implemented;

FIG. 2 is a block diagram illustrating an exemplary architecture of a platform server;

FIGS. 3A, 3B, and 3C illustrate differences in page and session view usage between conventional methods and CPS-backed methods;

FIG. 3D proposes a model for effective CPS and illustrates how this effective value compares against traditional advertising billing schema;

FIG. 3E illustrates differences in ad spending allocation between the traditional advertising billing schema and the proposed CPS-backed schema;

FIG. 4 provides a brief, general description of a representative environment in which a second embodiment of the invention can be implemented;

FIG. 5 is a schematic diagram that shows an example of the relationship between page transition and advertisement display in one embodiment of the technology introduced herein;

FIGS. 6A and 6B illustrate computation of Gross Rating Point (GRP);

FIG. 7 is a high-level block diagram showing an example of the architecture for a computer system;

FIG. 8 is a bidding portal for advertisers to place ad bids;

FIG. 9 is a flow diagram depicting an exemplary process for combining CPC and CPS based ad bids in a conventional ad auction;

FIGS. 10A, 10B and 10C illustrate an ad ecosystem where conventional page views are converted into sessions and CPS based ad bids are placed;

FIGS. 11A, 11B and 11C illustrate the various Key Performance Indicators (KPI) that are provided by the CPS based ad platform to help better understand an ad campaign's effectiveness;

FIGS. 12A, 12B and 12C illustrate an interactive ad slot used to track user interaction;

FIGS. 13A, 13B and 13C illustrate an ad slot that both displays advertisements and enables users to “keep”, “share” and “replay” the displayed advertisements;

FIG. 14 is a flow chart illustrating the time-variable CPS;

FIG. 15 illustrates an advertisement with a time-variable CPS c(t); and

FIG. 16 illustrates function f such that the function assigns \hat{m}ᵢ≅mᵢ if i≦θ and \hat{m}ᵢ<mᵢ if i>θ.

The headings provided herein are for convenience only and do not necessarily affect the scope or meaning of the claimed invention.

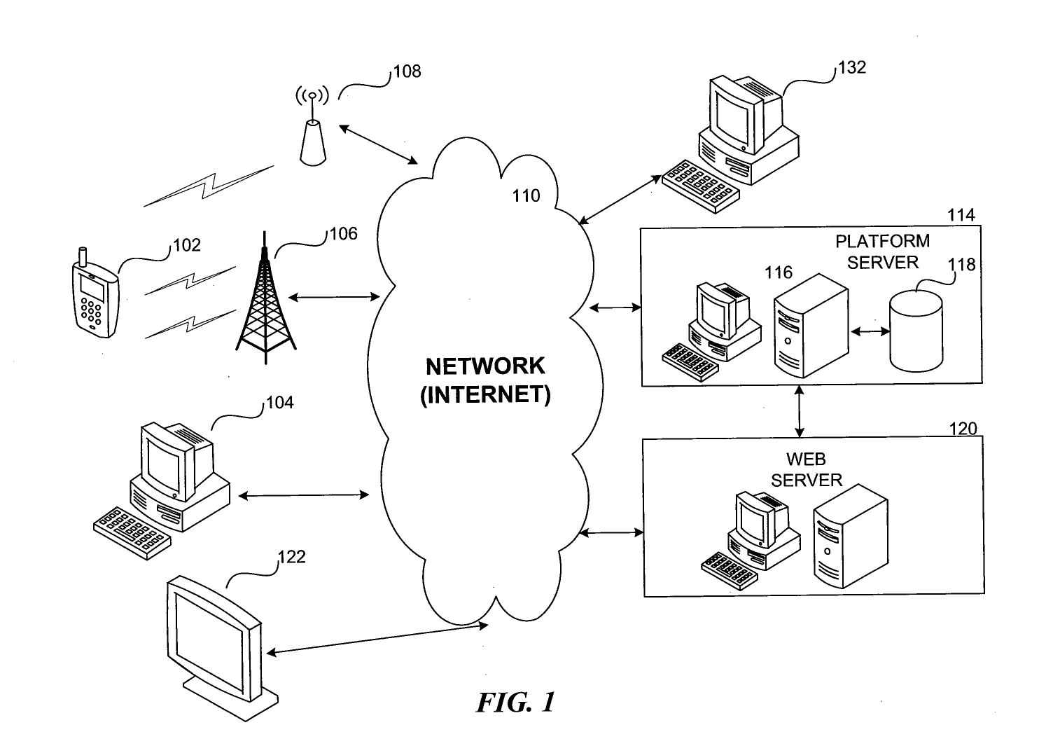

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 114 is first introduced and discussed with respect to FIG. 1).

### SUMMARY OF THE DESCRIPTION

The invention relates to processing and presenting a plurality of advertisements online.

In a first aspect, a method for advertisement processing is disclosed. The method includes receiving, from an advertiser, by a platform server having a processor, the advertisement to be displayed in an advertising section of a publisher's webpage, the advertisement intended for display for a predefined duration of time within the advertising section. The method further includes transmitting, by the platform server, the advertisement for display within the advertising section of the publisher's webpage. The method further includes determining, by the platform server, a first cost incurred for displaying a first portion of the advertisement, the first cost computed as a function of a first user interaction with the displayed first portion of the advertisement. The method further includes determining, by the platform server, a second cost incurred for displaying a second portion of the advertisement, the second cost computed as a function of a second user interaction with the displayed second portion of the advertisement. The method further includes computing, by the platform server, a total cost incurred for displaying both the first portion of the advertisement and the second portion of the advertisement, the final cost computed as a function of the first cost and the second cost.

Implementations can include any, all or none of the following features. The method further includes, wherein a given cost incurred for displaying a given portion of the advertisement is further computed as a function of a cost-per-second (CPS) model of displaying the advertisement within the advertising section, the cost-per-second model indicative of total duration of display of the given portion of the advertisement within the advertising section.

Additionally, the method further includes wherein when the given cost incurred for displaying the given portion of the advertisement is computed as a function of both the cost-per-second (CPS) model and a given user interaction with the given portion of the advertisement, the given cost is computed as an effective CPS (eCPS) value, the eCPS value being a function of a predetermined value associated with the given user interaction. The method could further include, wherein the given user interaction includes one or more of: (1) a mouse roll-over over the advertisement; (2) a user click of the advertisement; (3) a rewinding of the advertisement; (4) a pausing of the advertisement; (5) a playing of the advertisement; or (6) a entering of information into one or more forms associated with the advertisement.

The method can further include, wherein the predetermined value associated with the given user interaction is computed as a function of both a preference score associated with the given user interaction and a probability of occurrence of the given user interaction when displaying the given portion of the advertisement. The method can further include, wherein the preference score associated with the given user interaction is computed as a function of a desirability of the given user interaction to a given advertiser when displaying the given portion of the advertisement. The method can further include, wherein the probability of occurrence of the given user interaction when displaying the given portion of the advertisement is computed based on the number of on the nature of content included in the given portion of the advertisement. The method can further include, wherein the probability of occurrence of the given user interaction when displaying the given portion of the advertisement is further computed based on the number of occurrences of the given user interaction when displaying the given portion of the advertisement.

Implementations can include any, all or none of the following features. Other advantages and features will become apparent from the following description and claims. It should be understood that the description and specific examples are intended for purposes of illustration only and not intended to limit the scope of the present disclosure.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a phone 102, a personal computer 104, etc.) to communicate with a network and/or view displays communicated via the network 110. The term “phone,” as used herein, may be a cell phone, a personal digital assistant (PDA), a portable email device (e.g., a Blackberry®), a portable media player (e.g., an IPod Touch®), or any other device having communication capability to connect to the network. In one example, the phone 102 connects using one or more cellular transceivers or base station antennas 106 (in cellular implementations), access points, terminal adapters, routers or modems 108 (in IP-based telecommunications implementations), or combinations of the foregoing (in converged network embodiments). In some instances, one or more users may also use an electronic display 132 (e.g., an electronic overhead display, an electronic billboard display, etc.) to view information communicated via the network. In the context of this description, information communicated may include, for example, advertisements displayed either by themselves or advertisements displayed in conjunction with web pages or other online media a user may be watching/experiencing. Concepts behind display of such advertisements will be explained in further detail in the following sections.

In some instances, the network 110 is the Internet, allowing the phone 102 (with, for example, WiFi capability), the personal computer 104, or the electronic display 122 to access content offered via various servers (e.g., web server 120) connected via the network. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (COMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

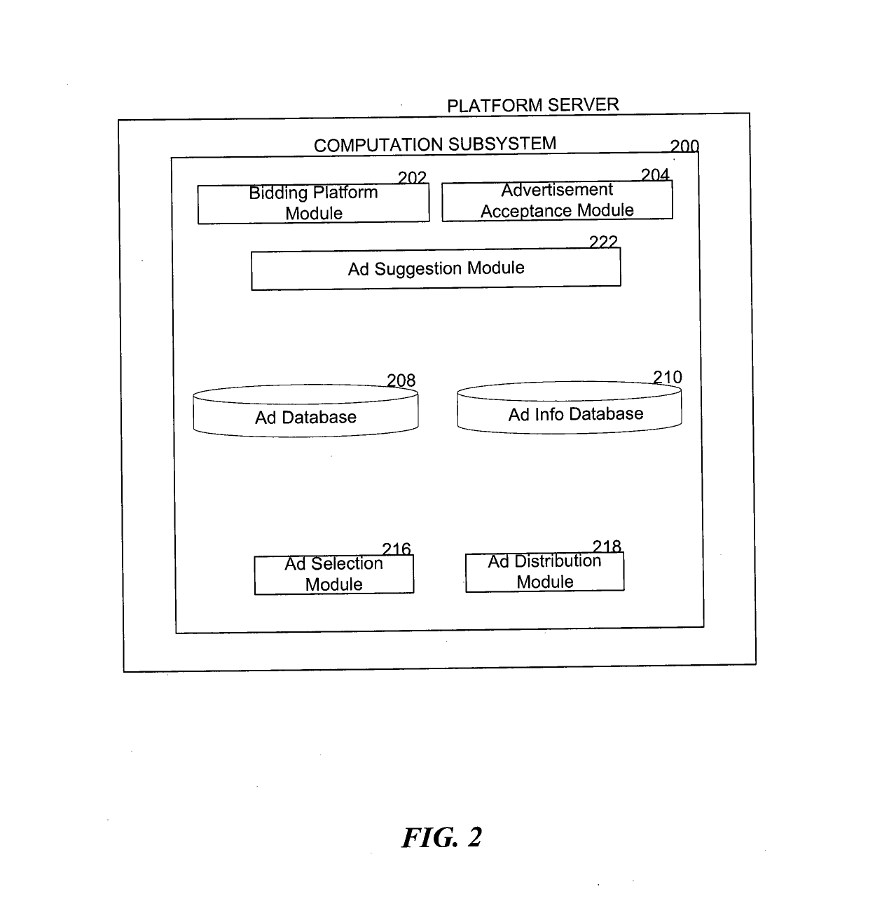

In some instances, a user uses one of the computing devices (e.g., the phone 102, the personal computer 104, etc.) to connect to an platform server 114 through the network 110. In one embodiment, the platform server 114 comprises a server computer 116 coupled to a local database 118. The term “platform server” as indicated herein, refers to an individual or multiple server stations or other computing apparatus. In one embodiment, the platform server is a web server capable of hosting a website and storing content (e.g., various webpages) that is associated with the website. In some embodiments, the platform server is separate from a web server, but communicates with a web server to provide, manage, and/or control content generated by the web server. In general, the platform server 114 includes various modules (either implemented as software or in hardware) that allow for advertising information to be collected from advertisers wishing to strategically engage in an advertising campaign, and to coordinate and relay ensuing advertisements to end systems. In embodiments, the platform server may independently coordinate the processing and eventual display of advertisements. In embodiments, as will be explained in the example of FIG. 2, the platform server may offer interfaces (e.g., APIs) to existing advertising network platforms to coordinate one or more specific advertising activities (e.g., providing abilities for bidding, providing campaign conversion modules, etc.) as will be explained in further detail below. As will also be explained in further detail herein, the administration server 114 incorporates one or more functional units to achieve each of the above discussed functionalities.

As shown in FIG. 1, in some embodiments, the personal computing devices and the administration server 114 are connected through the network 110 to one or more web servers (e.g., web server 120). Each web server corresponds to a computing station that enables a website provider, for example, to provide web content (e.g., web pages) that can be accessed by the personal computing devices through the network 110.

An platform server, as defined herein, could be a separate server offering the service described herein to, for example, one or more website providers. In other examples, the administration server could by itself be a website provider that also runs a service that accomplishes the techniques described herein. Additional examples of implementing an administration server, as understood by a person of ordinary skill in the art, are equally suitable for implementing the techniques described herein.

In the context of the systems described herein, in one embodiment, the platform server is implemented as a search system that enables advertisement display measures, allowing one or more advertisements to be shown either simultaneously or at various discrete timings based on advertisement data obtained through the network (e.g., from an advertising client 132). The platform server 114 may then communicate the advertisement to an advertisement display system (e.g., the user's personal computing device) in which the individual advertisements are shown for a predetermined length of time or according to variables established by the advertising client.

Consider an exemplary scenario where distinct advertisements x1, x2, x3, . . . xp are to be shown to the user as processed and output by the platform server 114. These advertisements are predetermined to be displayed for lengths of t1, t2, t3, . . . tp. However, this does mean that that the advertisement to be shown is also predetermined. For example, if a user browses and views the internet using a PC, various advertisements may be shown for various situations, and the techniques described herein includes the case in which these advertisements are shown and sustained for a predetermined length of time.

An advertisement, as described herein, includes without limitation movies, still images, banners, animated pictures, etc. As processed by the platform server, such advertisements are shown for a period and such periods may be predetermined, for example, by the advertiser. In cases where the advertisement is a movie, either the length of the prepared movie or the play time designated by the advertiser will be the display time for the advertisement. In cases where the advertisement is a still image, the display time will be the time designated by the advertiser.

The “display” of an advertisement refers to display of an advertisement that can be substantial or meaningful. For example, on a web screen, if the user scrolls down on the screen, it is preferable that the advertisement scrolls alongside to fit the screen on which it is displayed. However, if the above method is not possible and the user scrolls the screen to the extent that the advertisement is no longer visible on the screen displayed, the advertisement should be stopped, and the time that the advertisement had been played should be recorded (at least for the purpose of computing cost per second of display of the advertisement, as will be explained further below). When the advertisement returns to display on the screen, the advertisement should be resumed, and the total playing time will be recorded at the end of the advertisement or at the time of the next stop. The judgment of “whether the advertisement is displayed or not” can, for example, be that if a certain proportion of the advertisement is not shown within the screen, the advertisement can be considered to be “not displayed on the screen”. Here, a “certain proportion” can refer to a proportion at which substantial viewing of the advertisement can be deemed to be difficult, for example at a proportion of 50% or more. However, more than 50% is merely an example, and the proportion need not be limited to 50% or more. For example, the advertisement display can be divided into a major portion (e.g. the portion where the product or service name to be advertised is shown) and a minor portion, and when the major portion is shown on the screen, it may be judged that the advertisement is displayed on the screen.

The techniques discussed herein include a bidding system that allows an advertiser to place a bid for a certain spot and duration of advertisement. As illustrated with respect to FIG. 2, the platform server 114, in some embodiments, may include a bidding platform module 202 to enable the bidding operations. In the way of an example, the bidding platform module may present an appropriate GUI to the advertising client 132 to enable the advertiser to make appropriate selections and provide input. These are then taken in by the bidding platform module 202 for further processing and assessing for bidding.

In situations where the advertiser is aware of the display length beforehand, in embodiments, the advertiser may use bidding as the method of advertisement display time sales (“purchase” from the advertisers' perspective) in order to determine the order of precedence when displaying the advertisement(s). In other words, the amount of advertisement that can be displayed within an advertising space is generally finite. In addition, for web screens, if there is more than one advertisement that can be shown on the same advertisement space, the order in which the advertisements are placed becomes important. Specifically, when displaying advertisements on a specific advertisement space or for specific keywords, an input is made (e.g., in the form of a bid) for the maximum cost/price that the advertiser can bear for that particular combination of duration and order. It is evident that the order or precedence will be higher when this cost/price is higher.

The following are sample pseudo codes for determination of parameters/events for an effective “display” of an advertisement:

(1) Determination of ads playing across page views.

(2) Detection of mouse roll-over over a given area in a given page view.

(3) Real-time verification/measurement of percentage of screen area covered by an ad.

Pseudo Code:
(1) Determination of ads playing across page views:

```
if (hasContext( )) {
  sendLog( );
  deleteContext( );
  playContext( );
  sendLog( );
} else {
  sendLog( );
  playAd( );
  sendLog( ):
}
eventhook(unload) {
  sendLog( );
  saveContext( );
}
```

(2) Detection of mouse roll-over over a given area in a given page view

```
eventhook(mousein) {
  sendLog( );
  enlargeWindow( );
}
eventhook(mouseout) {
  sendLog( );
  reduceWindow( );
}
```

(3) Real-time verification/measurement of percentage of screen area covered by an ad

```
eventhook(resize) {
  WindowArea = width*height;
  sendLog(AdArea, WindowArea);
}
eventhook(mousein) {
  enlargeAdWindow( );
  AdArea = AdWidth*AdHeight;
  sendLog(AdArea, WindowArea);
}
eventhook(mouseout) {
  reduceAdWindow( );
  AdArea = AdWidth*AdHeight;
  sendLog(AdArea, WindowArea);
}
```

### Cost Per Second (CPS) Based Technology

In at least some embodiments as disclosed herein, the length of time that an advertisement will be shown will vary not only according to the advertisement itself, but also according to secondary factors (e.g., keywords, search relevance, etc.). For example, when publishing an advertisement on a search result page, conventionally, bids are placed for a certain keyword A, and the advertisement to be displayed with higher priority is determined and fixed according to this price. On the other hand, for this invention, comparisons are not made according to the price per display (or impression) of an advertisement, but by the bid on the price per unit of time, or Cost per Second (CPS). Bids can be placed directly through CPS, or the cost per advertisement can be used as the unit of bid, and divided by the number of seconds of advertisement display in order to calculate the CPS to compare prices between various advertisements.

For example, assume that there exist two advertisement spaces (F1 and F2) on a search result page for a certain keyword A, and that the advertisement effect of advertisement space F1 excels that of advertisement space F2. If advertiser D1 bids for price P1, advertiser D2 bids for price P2, advertiser D3 bids for price P3 and P1>P2>P3, conventionally, advertiser D1 won advertisement space F1, advertiser D2 won advertisement space F2 and advertiser D3 could not win an advertisement space. As a result, the publisher/media can only utilize two advertisement spaces (and lose revenue from advertiser D3), and advertiser D3 would lose the opportunity to advertise.

However, using technology introduced herein, for example, the publisher/media can sell the two advertisement spaces (F1 and F2) separately at the time of the bid. For example, for advertisement space F1 advertiser D1 bids for a CPS price P1, advertiser D2 bids for a CPS price P2, advertiser D3 bids for a CPS price P3 and P1>P2>P3, the advertisement display time for F1 can be sold to advertiser D1, advertiser D2 and advertiser D3 in the respective order.

Additionally, if the total time that the advertisements are played for each advertisers D1, D2 and D3 are T1, T2 and T3, respectively, in simple terms, the publisher/media receives an advertising revenue of P1×T1+P2×T2+P3×T3 (in reality, if the displayable time exceeds T1+T2+T3, the order of priority will be determined as D1>D2>D3. Additionally, the order of priority can be changed according to other factors such as the time in the day, etc.). As a result, the publisher/media can utilize their advertisement space with higher efficiency, and each advertiser will be able to display advertisements with higher efficacy. In other words, if each advertisers' advertisement (assuming that each had one type of advertisement) has a display length of t1, t2 and t3 per advertisement, each advertiser will be able to publish T1/t1, T2/t2 and T3/t3 advertisements respectively (assuming that there is no upper limit to the display time). For the user, the amount of information received would be greater than the conventional cases in which one advertisement is shown repeatedly. However, it should be noted that the above example is a highly simplified version. Alternately, a better system may be one that incorporates a display method in which the price determination method is consistent with that in the conventional market.

As offered by the CPS technology introduced herein, the advertisement billing is based on CPS×Seconds Displayed. In embodiments, the cost charged to the advertiser is based on the actual display time. This is because the purchase of the advertisement space is not for an entire unit based of a single display, but for the price/cost per second of an advertisement that will be shown only for a certain time length. The “actual display time” should ideally be the “time that the user is actually watching.” The actual display time may be measured using techniques as understood by people of ordinary skill in the art at the time of this application. However, in systems where constraints are present due to, for example, cost and facilities, the realistic time measurement used be the “time that the advertisement is shown on the screen”. In other words, the advertisement display time will be measured as the “period in which the advertisement is displayed on the screen”.

Accordingly, in embodiments, advertisements are shown for a certain periods of time. In other words, the advertisements displayed will have a designated order or priority, and more than one advertisement may be shown continuously in a loop. The order, precedence, and length of running such advertisements may be based on a variety of factors. Such factors may be accounted for, for example, through the bidding platform offered in conjunction with the platform server. An example of such a factor may be an order of priority (e.g. time of the day). When such a factor is introduced, it is not known under which conditions the advertisement should be displayed for higher effectiveness. One way to overcome this issue would be to play the advertisements in varying orders with equal likeliness. When this is the case, a statistically significant sample size will be chosen, and various orders will be tested for this sample. The index when evaluating the effectiveness can be, for example, Seconds per Click (SPC), or the number of seconds necessary until the user clicks the advertisement. Analyzing that information over, for example, the time of day such events occur, statistical information may be collected to determine order of priority and corresponding bid value for placing advertisements on the web screens. Using these results, the advertisements can be shown in the order of this index.

The explanation illustrated an example of a case in which advertisements are shown on a search result page, but it is understood that the techniques discussed herein may be applied to a variety of other advertisement types as well. For example, the techniques introduced herein include a novel online advertisement concept where direct response advertisement and branding advertisement are both combined (the product of the two is taken) Correspondingly, there are two main types of advertisement sales: (1) the CPS (cost per second) mode of advertisement sales (as discussed above); and (2) the product of CPS and Cost per Click (CPC), which would be CPS×CPC. CPS is the price per second of advertisement display, and CPC is the cost that the advertiser bears when a user clicks on an advertisement while watching an advertisement and jumps to a website designated by the advertiser. In order to determine the order of priority of advertisement display, the prices of advertisements (e.g., as placed in bid values) are compared, but in an exemplary scenario, a value in which both the CPS and the CPC are included may also be considered in assessing relevance and priority of the bidders. As indicated here, N=CPS×CPC may be a simple case for accounting the CPS and CPC elements jointly, but it is understood that other conversion formulas where the two elements may be effectively considered may also be used.

In embodiments, the platform server 114 includes logic for the purposes of determination of the two types of cost determination and to identify targets and correlation between the two types. In embodiments, and as illustrated in FIG. 2, the platform server may include one or more of the following modules, each being implemented either in hardware, software, or firmware, or a combination thereof: an advertisement (or ad) suggestion module 222 to make determinations and provide according suggestions as to the type, content, duration, etc. of advertisements to be placed on various publishers' sites. The logic incorporated in this module may include, for example, algorithms to identify significance, meaning, context, relevance, etc. of a particular website and accordingly identify relevant advertisements. Further, the platform server 114 may include an advertisement accepting means 204 for accepting advertisements uploaded by advertising clients 132. In embodiments, the platform server 114 may also include advertisement memory 208 for storing advertisements received from advertisers and advertisement information memory 210 for storing information related to advertisements (e.g., relevance information, order or priority information, etc.). In some instances, the modules may further include an ad selection module 216 and an ad distribution module 218 that are configured respectively to select an appropriate ad and to transmit the ad to a predetermined web screen based on determinations made by the platform server.

In embodiments, these include means that are accessible online by the advertiser. Each component/module identified above may be implemented as discrete software or hardware units or a combination thereof. In embodiments, for example, the advertisement space suggestion module to suggest advertisements for publishing on advertisements spaces and the advertisement bidding means can be combined into or be coupled to a web server 120. In embodiments, the structure of the platform may include, for example (in the case of displaying advertisements in a search result page), a GUI to suggest a page in which the keywords used for the search, the various attributes of the user to which the advertisement is desired to be displayed (gender, age, region, profession, educational background, hobbies, etc), the preferred time of the day to display the advertisement can be entered, etc. According to these entered inputs, the price per unit of time for purchasing the advertisement space and the entry field for purchasing the advertisement space (or an entry page) will be then be displayed. For the suggested advertisement space, the advertiser inputs (e.g., through the bidding platform) the desired price per unit of time to purchase the advertisement space, and the number of advertisement spaces to purchase. However, in embodiments, the purchasing of advertisement space can be for the total length of time that the advertisement will be displayed.

In embodiments, the advertisement information memory 210 and the advertisement data memory 212 to store the advertisement itself may include, for example, advertisement information database means to store information related to the advertisement and an advertisement data database means respectively to store the advertisement itself.

To reiterate, the CPS methodology for pricing advertisements has unique fairness and efficiency considerations over conventional systems as outlined below.

Fairness:

With the adoption of the CPS methodologies discussed herein, pricing becomes fair relative to conventional systems. For example, an advertiser uploads a 15-seconds ad, bids $0.02/sec for CPS, and an optional $0.3 for CPC. If a user stays 10 seconds and clicks on the ad, the advertiser pays $0.50. If the user stays for 2 seconds and does not click, the advertiser pays $0.04 (FIG. 2-1). That contributes to considerable improvement in fair value-for-money (VFM).

Additionally, the advertisers are charged according to the size of the ad space, where for example, an ad space occupying 30% of the viewing area in a page view attracts a higher ad placement cost than an ad space occupying just 10% of the viewing area in a page view. The rationale behind such a model could be that the bigger the size of ad display, the greater the chance that the ad will attract a user's attention and create the desired impression. Further, the methodology could account for change in size of ad space in a page view and reflect the change in pricing of cost of ad placement in that page view. In embodiments, the users could be allowed to customize the ad space in their page view. For example, the users could customize the ad space similar to that of a web page loaded in a web browser. The user could minimize the ad space to one of the corners of the page view, drag and drop the ad space in any section of the page view, expand or shrink the ad space, etc. In embodiments, the final cost of the ad placement in the CPS methodology will reflect the cost for placing the ad in the final customized ad space. Further, the specifications of the final customized ad space can be captured and stored, for example, in a web browser cookie. The stored specification can later be used to configure the ad space for the user in other web pages, while using the specification to predetermine the CPS based cost of placing an ad in such an ad space. That further contributes to considerable improvement in fair value-for-money (VFM).

Efficiency:

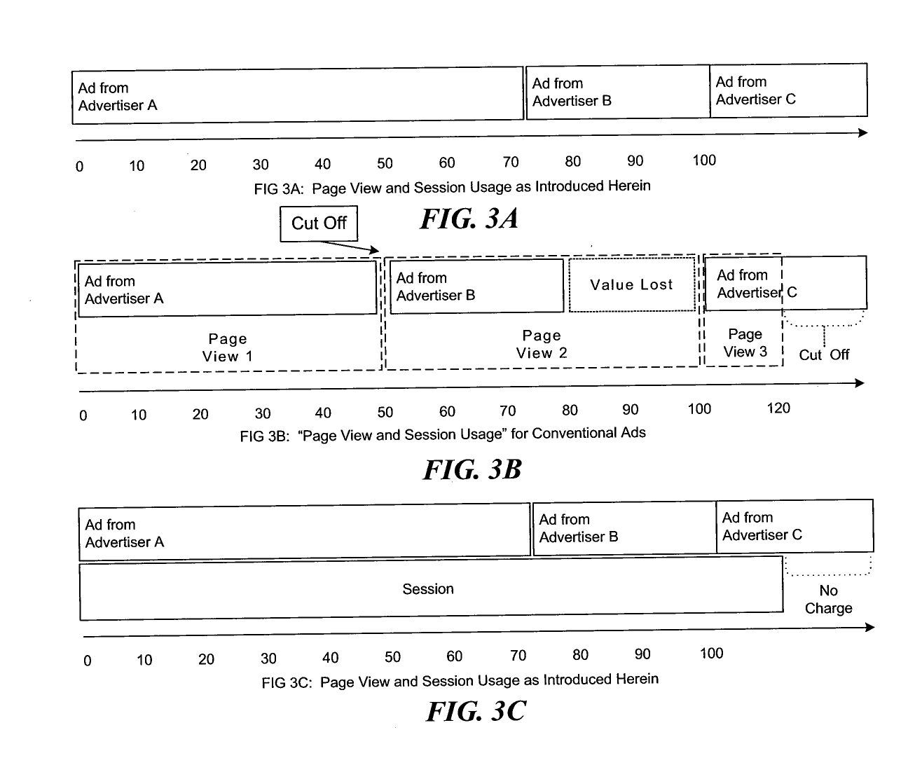

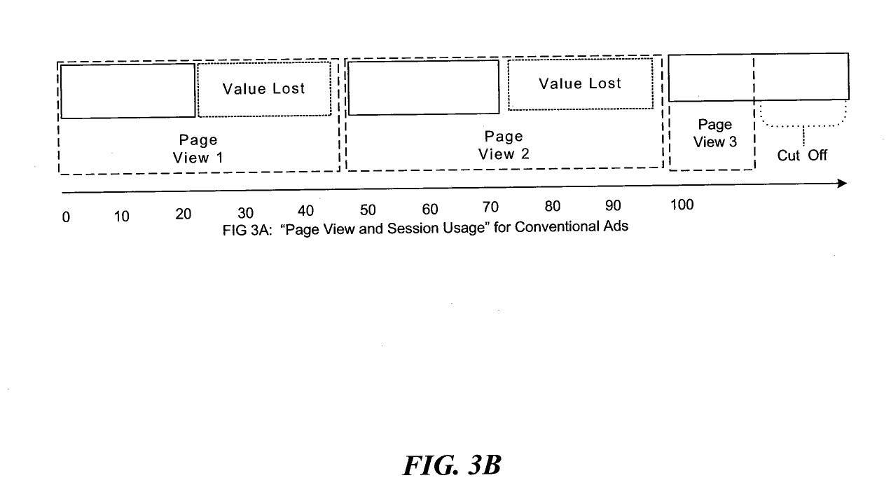

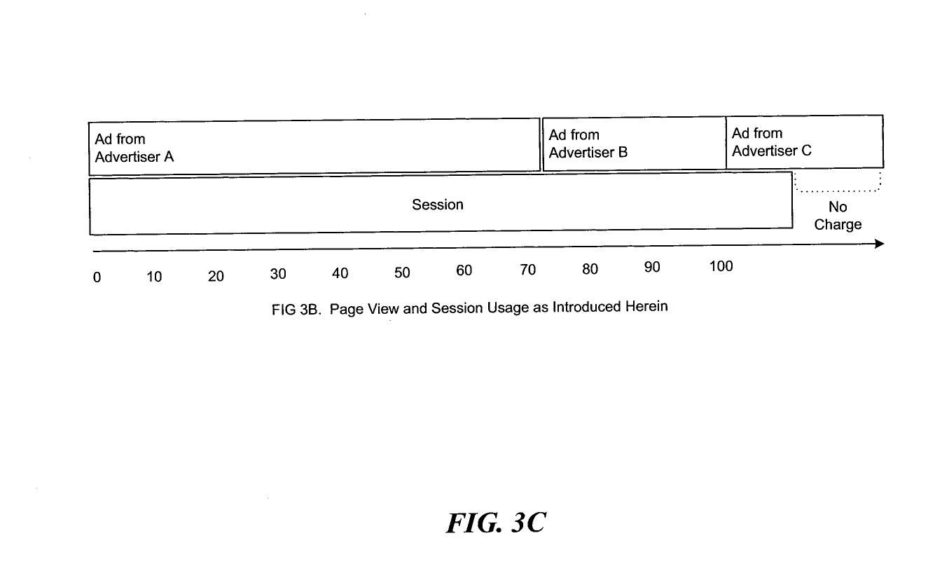

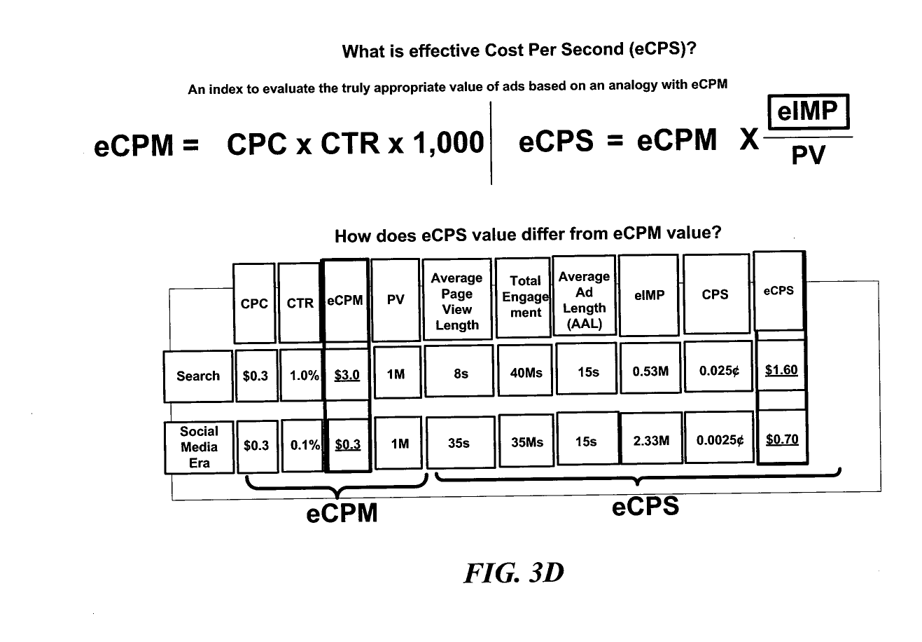

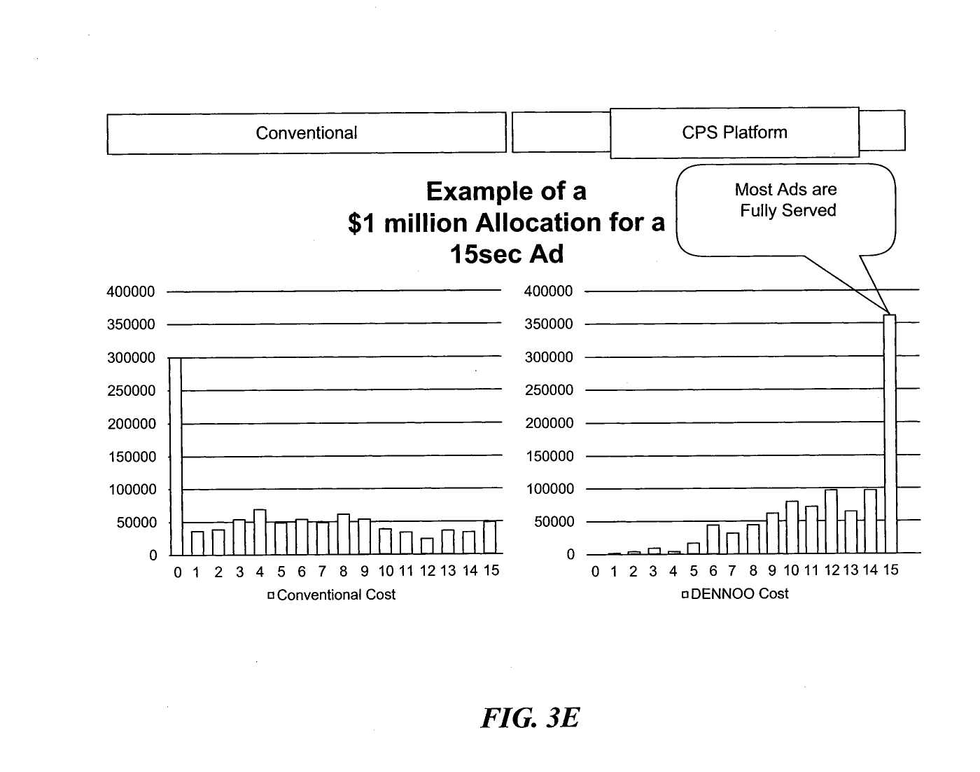

Session and page view usage becomes efficient with use of CPS methodologies, which are discussed in detail herein. For example, as illustrated in FIGS. 3A and 3B, in conventional display ads, a user session in a publisher's website is dissected into multiple page views and each page view is constituted as an independent ad slot. The time a user stays on a given page before changing pages constitutes a page view. So, every time a user visits a publisher's website, the user could potentially view multiple web pages in the publisher's website. The visit could thus result in multiple page views with each page view constituting an independent ad slot. As illustrated in FIG. 3B, in a 110-second user session on a given publisher's website, the user had three page views of about 45 seconds, 55 seconds, and 10 seconds, respectively. A 70 second ad from Advertiser A was displayed for only 45 seconds on page view 1.

A full 30 second ad from Advertiser B was displayed on page view 2 and a 25 second ad from Advertiser C was displayed on page view 3 for only 10 seconds. In this page view based system, ads either only takes up a portion of the page view, or conversely, the page view is not long enough to show the entire ad. As illustrated in FIG. 3B, this typically leads to severe loss in efficiency: lower VFM for advertisers as they are charged for the cost of a full ad even when the ads are not fully played, and smaller, less efficient inventory for publishers.

In the CPS methodology, however, as illustrated in FIG. 3C, the entire user session becomes a single unit ad slot, dissected into seconds. Sessions can be tailored to the exact needs of advertisers. Page views will no longer matter, and the flexibility, efficiency and effectiveness of advertisements improve significantly. When using advertisements of variable lengths such as those devised by the techniques described herein, the switching of advertisements are based not on page transition, but on time. A user transition from one page view to another does not cut-off an ad, Instead, the ad is resumed in the next page view until it is fully played. For example, in a 110-second user session, 70 seconds can be allocated to advertiser 1, another 30 seconds to advertiser B, and 5 seconds to advertiser C. When the user transitions from page view 1 to page view 2 after 45 seconds, 25 seconds of play-time is still left on ad A. Therefore, ad A is resumed and played for the remaining 25 seconds in page view 2 before ad B is played. Once ad A is complete, ad B is played for 30 seconds. When the user transitions to page view 3, and B is fully played. So, ad C starts playing at the beginning of page view 3. However, the user ends the session with 20 seconds of play-time left in ad C. Therefore, the advertiser is charged only for the 5 seconds of the 25 second play-time ad C was played. Thus, page views will no longer matter, and the flexibility, efficiency and effectiveness of advertisements improve significantly.

The CPS methodology, thus, addresses the severe loss in efficiency associated with the conventional internet advertisement system: improved VFM for advertisers as they are charged, not by ad slots, but by the total play-time for a given ad, and a larger, more efficient inventory for publishers. When this revived value is aggregated for the entire market, the overall opportunity and improvement is enormous, in FIG. 3E, the graphs illustrate how $1 million was allocated for a 15 sec long ad campaign in the conventional and the CPS-based ad platform respectively. In the conventional ad platform, 30% of the $1 million allocation was spent on ads that received zero play-time. This is possible in the conventional ad platform because the advertisers are charged by page view. In the event the user changes page when the ad is loading, the advertiser is still charged for the page view with literally no ad play-time. As can be seen in the FIG. 3E, only $50,000 out of the $1 million spent on ads received the full play-time. On the other hand, in the CPS-based ad platform, advertisers pay based on the actual play-time received by the ad and not by page views. So, instead of $50,000, $350,000 of the $1 million spent on ads received the full play-time. Furthermore, the rest of the $1 million goes towards ads that received substantial play-time while nothing was spent on ads that received zero play-time. Thus, this revived value for advertisers and publishers, when aggregated for the entire market, presents an enormous improvement over the conventional internet ad platform.

Returning back to the illustration of FIG. 1, the process of utilizing the platform server to process and display advertisements is now explained with respect to two scenarios: (1) when the advertisement is returned to a user viewing the advertisement in a web screen; (2) when the advertisement is displayed to multiple users over an electronic display instrument (e.g., an electronic bill board).

As illustrated in FIG. 1, when the advertiser accesses the bidding platform module of the platform server 114, the system, for example, suggests an entry field for the desired conditions regarding the advertisement display. The advertiser 132 inputs the desired conditions accordingly. In response, the platform server 114 may request entry of an advertisement. The received advertisement and advertisement information is then stored in the advertisement video database and the advertisement information database by the advertisement reception device. In embodiments, the information stored in the advertisement video database and the information stored in the advertisement information database are related and attributed by an advertisement ID that is unique to each advertisement. In embodiments, when the advertisement information is transmitted to a display device, the related information may also be attributed by the advertisement ID.

In the first scenario, the user typically has an advertisement display device that is loaded into the web browser (e.g., a widget within a web page, etc.). At this time, in order to display advertisements that match the user's interests, information regarding the page shown and user IDs are sent to the advertisement selection device of the platform server. An advertisement selection module 216 selects the advertisement(s) to be displayed based on the received information and the advertisement data stored in the advertisement information database. The advertisement selection module 216 selects the advertisements to be shown, and the advertisement ID of the advertisement to be shown will be sent to the advertisement screening device (e.g., the user's computer).

After receiving one or more advertisement IDs from the advertisement selection module 216, the advertisement transmitting or distribution module 218 sends one or more advertisements continuously to the advertisement display device. The advertisement screening device displays the advertisement to the user upon reception. For videos, the display time is generally determined by the length that the video advertisement is played. For still images, the display time is determined by the time designated by the advertiser.

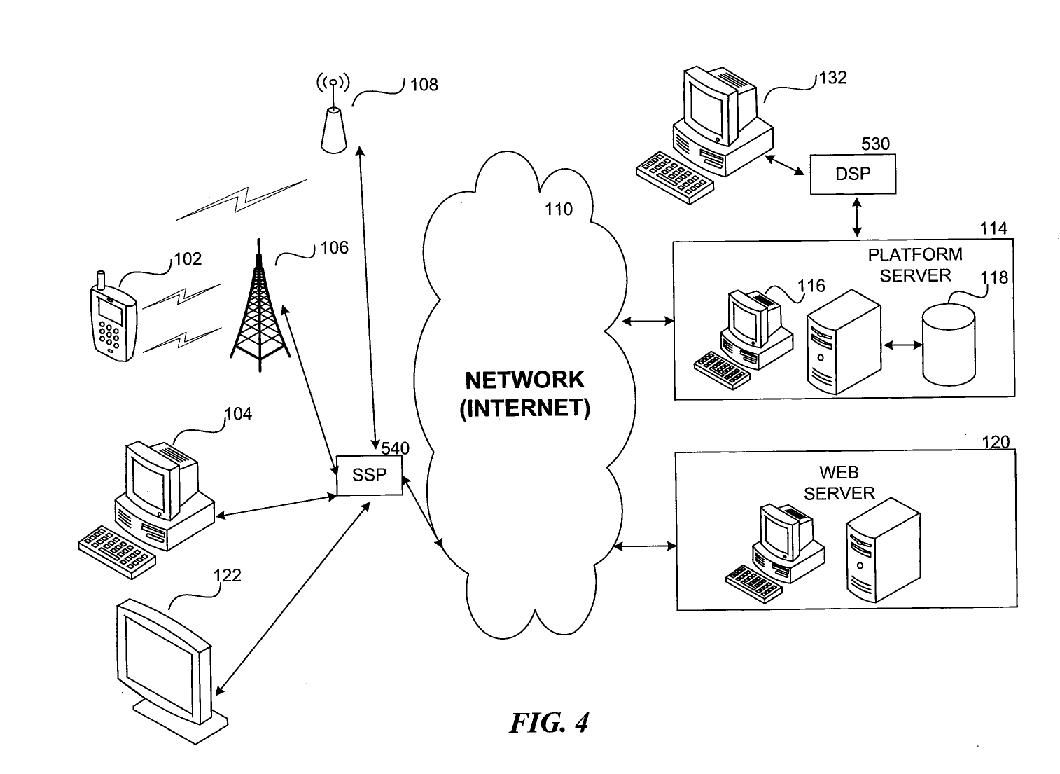

FIG. 4 illustrates the second scenario, where the advertisement display device with which the user watches advertisements is not equipped on the browser, but rather a device that is connected to the internet, such as on an LCD display for street advertising (e.g., device 122). In this scenario, the advertisement display device is not equipped on a web browser, so information as to the basis of selecting the advertisement to display may not exist. In such cases, the advertisement display device does not send out information for advertisement selection, but instead just display the advertisements continuously in a predetermined order. However, for example, if a digital signage device is located in various stores and locations, it is possible that conditions for selecting the advertisement, such as showing it on a device in a ramen noodle store in the shopping quarters from 5 PM to 11 PM, are specified and the advertisements are shown accordingly. In such cases, the advertisement that best matches such conditions may be selected. For videos, the display time is generally determined by the length that the video advertisement is played. For still images, the display time is determined by the time designated by the advertiser

A third scenario of processing and displaying advertisements in accordance with the techniques discussed herein is illustrated with reference to FIG. 4. In this example, the publishing of advertisements and the displaying on the advertisement viewing device are carried out not directly between the advertiser and the user, but by using interfaces to a Demand Side Platform (DSP) 530 and a Supply Side Platform (SSP) 540. The composition of this exemplary embodiment constitutes an advertisement exchange that can incorporate the present teachings with conventional advertising exchanges.

In embodiments, either the DSP, SSP or both may be included. The composition can be either through a connection with the DSP, a composition with a direct connection to the advertiser, or a combination thereof. Similarly, the composition can be either through a connection with the SSP, a composition with a direct connection to the user, or a combination. Other similar combinations of one or more DSPs and SSPs, as may be contemplated by a person of ordinary skill in the art, may also be used as alternate or variants of the above discussed composition.

In this example, when the advertisement is sent by the advertiser, it is stored in the DSP, which acts as the mediator on the advertiser's side. The DSP then selects an advertisement exchange from among the advertisement exchanges, and the advertisement is published. In order for the device devised by this invention to receive the advertisement, a bid to determine the price of the advertisement is received from the advertiser through the DSP.

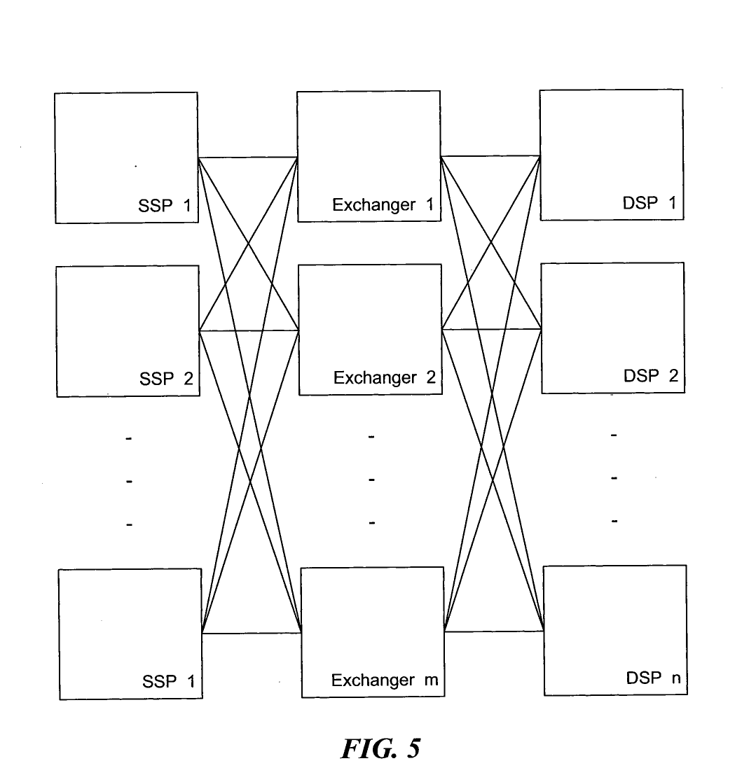

On the other hand, on the user's side, the advertisement is received not directly from the device devised by this advertisement, but from the SSP, and the advertisement is shown. After receiving the advertisement display request from the user, the SSP selects one or more advertisement exchanges to receive advertisements from, and requests for advertisements. At this time, the system (advertisement exchange) devised by this invention, which has received the advertisement request, also receives information necessary to select the advertisement that best matches the user, and according to this information, chooses the best-match advertisement from the displayable advertisements, sending the advertisement to the SSP. After receiving the advertisement, the SSP sends the advertisement to the user, and the user watches the advertisement. One such exemplary composition is illustrated in FIG. 5.

In embodiments, with such a composition, the advertising side can increase the effectiveness of their advertisement by widening the array of media/publishers to display their advertisements on. The results in quantifiable advantages on both sides of the spectrum—on the media/publisher side that will show advertisements, revenue for advertisement spaces increases by allowing for selection from a larger number of advertisements the advertisement that best matches the users' interests. From the users' perspective, for similar reasons, advertisements will be chosen from a greater variety, and the users will be able to watch advertisements that match the users' interests.

### Conversion Approaches for Conventional Vs CPS-Based Billing Schema

As illustrated in scenario 3 above (with reference to FIG. 5), advertisement bidding by the advertiser may also be conducted through DSPs. In such cases, because conventional Internet advertisements bids are placed based on the Cost per Click (CPC) or the Cost per Mille Impressions (CPM), and bids according to the technologies described herein are placed either based on Cost per Second (CPS) or a function of CPS and CPC (e.g., CPS×CPC) for branding as well as direct-response-hybrid-bidding, the various modes of bidding cannot be compared readily. Therefore, a conversion formula is very useful in allowing an advertiser to readily understand the impact of this new approach and also appreciate the cost savings and efficiency of the CPS based approach. Some such conversion approaches are described herein.

Process by which eCPM Value is Converted into eCPS Value.

The effective Cost per Mille (eCPM), or the cost for displaying an advertisement 1000 times for a subject to be displayed, based on past data, is used as a standard for bidding prices. Generally, in such cases, comparison of CPM and CPC is done with eCPM as the intermediary. In other words, when the expected or actual Click Through Rate (CTR) is considered,

eCPM=CPC×CTR×1000 (1)

First, effective CPS (eCPS) is defined as below:

$$eCPS = eCPM \times \frac{eImp}{PV} \qquad ( 2 )$$

where PV is “total number of page view”, eImp is “effective impression”, and eCPM is “effective CPM”. eCPM is defined above as indicated in equation (1). Effective impression (eImp) is a value that is incorporated in the conversion, and is defined as:

$$eImp = \frac{PV \times AVT}{AAL} \qquad ( 3 )$$

Here, AAL is the average ad length, which is the average length of all ads on the media under consideration. In general terms, AAL is a function of ad lengths, i.e. AAL=f(Ad lengths). In one embodiment, AAL could be an simple average of ad lengths, i.e. AAL=(Sum of Ad Lengths)/(Number of Ads). In another embodiment, AAL could be a weighted average of ad lengths, i.e. AAL=(weighted sum of Ad Lengths)/(Number of Ads)”. Thus, in general terms, AAL is a function of ad lengths, i.e. AAL=f(Ad lengths).

Here, AVT, or the average viewable time is defined as the sum of all ad view lengths (AVL) on the media divided by the total number of page views (PV) on the media. The equation is below:

$$AVT = \frac{\sum AVL}{PV} \qquad ( 4 )$$

Based on the above equations, eCPS may also be written as:

$$eCPS = eCPM \times \frac{AVL}{AAL} \qquad ( 5 )$$

With the above equations, accordingly, eCPM value may then be converted to an eCPS value. See, e.g., FIG. 3D for an approach for comparing eCPM to eCPS and to determine how eCPS value differs from traditional values. Further, In the above equations, the left side of the equation is the value devised based on the techniques introduced herein, and the right side of the equation is the value based on conventional technology. Using such conversion formulas, a value that corresponds to eCPM can be calculated in the system devised as a result of the techniques disclosed herein, allowing the variable length advertisement display system of the present application and other conventional systems to exchange advertisements seamlessly. It is noted that the equation illustrated above is merely an example, and that other conversion formulas, as may be evident to a person of ordinary skill in the art to be obvious variants of the above equation, are also valid examples.

As illustrated above with reference to FIG. 3D, an eCPM value may now be converted to an eCPS value. From a publishers perspective, eCPM represents an expected bid for advertising in a publisher's website under the conventional internet advertisement technology. Similarly, the eCPS represents an expected bid for advertising in a publisher's website under the CPS-based advertisement technology introduced herein. As illustrated in FIG. 3D, the conventional eCPM valuation, developed for keyword based advertisement, emphasizes search-based advertisement while seriously undervaluing media/branding-based advertisement. In FIG. 3D, the expected bid for a search-based advertisement is $3.0 while that for a media-based advertisement is only $0.3. The key reason for the huge disparity in bid costs between the two publisher types is the emphasis on CTR in conventional internet advertisement technology, which does not account for the high branding potential achieved through media-based advertisement.

One of the important features of the technology introduced herein is that “high quality media with higher levels of user engagement”, which had been seriously undervalued due to the conventional eCPM valuation, will be able to sell their advertisement space based on the full branding potential achieved through their “high quality media”. Additionally, the technology enables value to be revived and allows these “high quality media” to receive advertisement fees commensurate with their “high quality” contents. On media that have “high quality” content, the users stay at pages longer, have longer sessions, and will not readily depart or jump away from pages. As a result, CTR is lower, and when calculations of advertisement value are conducted using eCPM, the price for advertisement on this media turns out to be lower than “low quality” media such as a website that is packed with links (thus having higher CTR). However, as disclosed herein with reference to the CPS-based technology, such discrepancy is resolved by valuing high quality media for the high quality of their contents.

As illustrated in FIG. 3D, eCPS is the eCPM that can be expected for the publisher in the system that is devised using the techniques introduced herein, and if this value is larger than the eCPM value for conventional technology, it can be expected that the publisher/media will earn a higher revenue from the increased bids. In FIG. 3D, the media based publisher can now expect $0.7 in a CPS-based advertisement platform instead of just $0.3 in a conventional advertisement technology based platform. CPS-based technology would thus allow for market value lost by conventional technology to be rediscovered, the underrated value to be evaluated appropriately, and the entire market to be revitalized. Overall, the technology allows media based publishers to publish and benefit from higher quality contents, imparting benefits to the entire advertising ecosystem—the publisher, the advertiser, and the user.

Illustration of Ecosystem Utilizing CPS Scheme within Conventional Market

As illustrated above with reference to FIGS. 3B to 3D, the methods and systems disclosed herein also interoperate with conventional systems when, for example, connected via a DSP. The following section discloses the CPS based advertising platform, where various types of bidding schemes, including bidding schemes based on conventional parameters may be accepted and conversion schema applied to allow for interoperability. When the advertiser is bidding by CPM, the system disclosed herein converts this bid into CPS. In conventional systems, if an advertiser bids by CPM, the price per 1000 page views was constant regardless of the number of clicks. In the system devised by this invention, advertisement slots are not sold by page views (PVs). As described above, in the CPS methodology, the entire user session becomes a single unit ad slot, dissected finely into seconds. Sessions are tailored to the exact needs of advertisers. Page views no longer matter, and the flexibility, efficiency and effectiveness of advertisements improve significantly. When using advertisements of variable lengths such as those devised by the techniques described herein, the switching of advertisements are based not on page transition but on time.

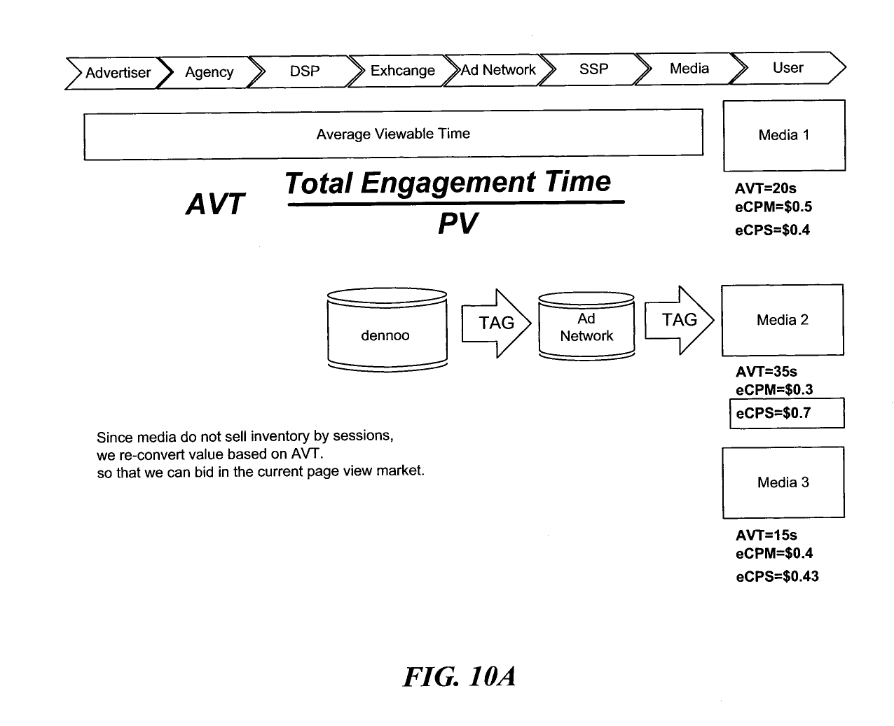

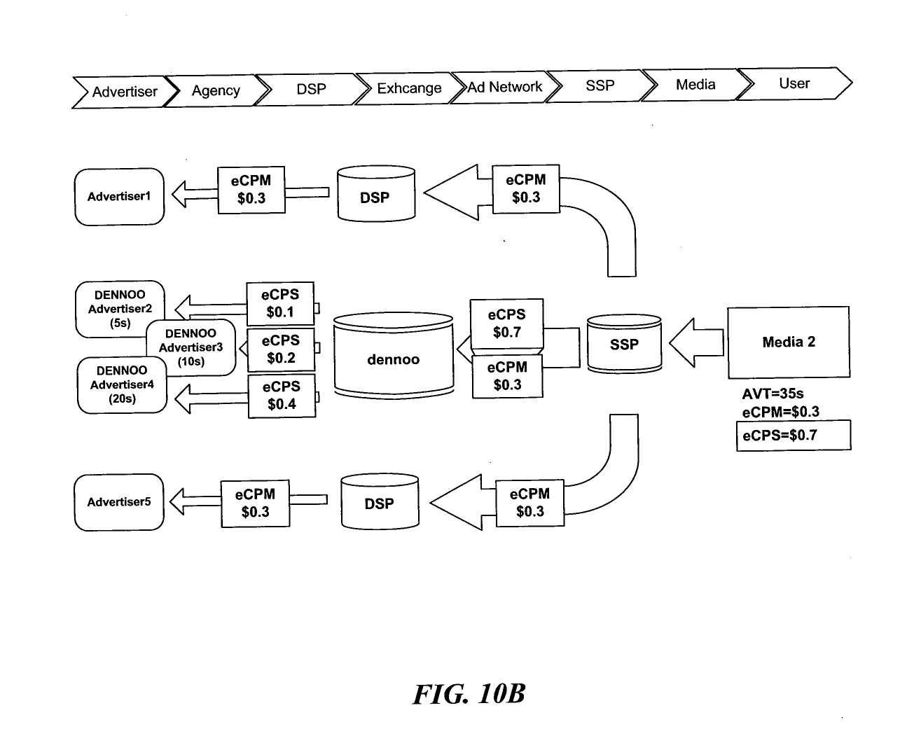

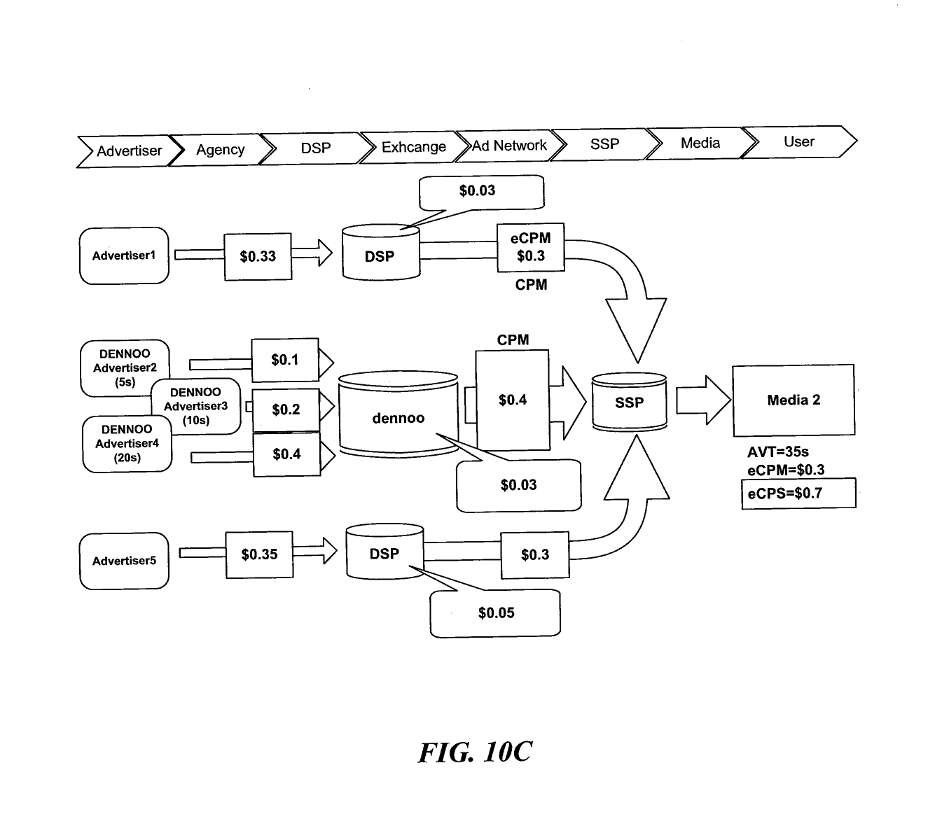

FIG. 10A illustrates how AVT is computed for each media requesting an ad placement through an Ad network. Media publishers generally request ad placement requests through Ad networks. In the conventional internet ad market, the ad slot inventory is sold in units of page views, where the advertisers, for e.g., pay eCPM per page view. In order to enable CPS based advertisement platform to work with the conventional platform, the page view market needs to be converted to sessions. In this embodiment, the session length is estimated based on AVT. By placing monitoring tags in each of the publisher's media, the Ad network and in turn Dennoo (i.e. a DSP) can monitor both the number of page views and the total engagement time of all ad views to compute the AVT. As described above, based on the AVT, Dennoo can now compute the eCPS for the media requesting ad placement. Using the conventional eCPM valuation and the Dennoo computed eCPS ad valuation, Dennoo can identify media publishers who are undervalued in the current ad market. Media publishers who have a lower eCPM than eCPS can thus expect better valuation by treating ad slots as CPS based sessions instead of conventional page views based scheme. For example, in FIG. 10A, unlike Media1 and Media3, Media2 has a higher eCPS valuation than the conventional eCPM valuation. The eCPS valuation is in fact more than double the eCPM valuation of the ad slot in Media2. Dennoo will target ad placement in such undervalued media publishers using bid amounts based on eCPS valuation than the conventional eCPM valuation. The resulting higher valuation, based on the spread between eCPM and eCPS valuation, increases Dennoo's chance of winning the bid and monetizing the undervalued ad slot.

In FIG. 10B, an SSP, such as an Ad network, can forward the Media2's ad placement requests to various DSPs, including Dennoo, with the conventional eCPM valuation of $0.3 for the ad slot. DSPs, following the conventional eCPM system, forward the ad placement request to the advertisers and the associated eCPM value. The advertisers, in turn, utilize the eCPM value to generate an ad placement bid, with the eCPM forming the basis of the bid amount. Dennoo, using AVT, generally first computes the session length of the page views in Media2 and the corresponding eCPS bid valuation for the ad slot. Media2 has an AVT value of 35 seconds and a corresponding eCPS valuation of $0.7. Dennoo, instead of forwarding a single ad placement request for eCPM value of $0.3, sends three ad placement requests of $0.1, $0.2, and $0.4, which fully monetize the 0.7 eCPS valuation. Also, instead of forwarding ad placement requests to advertisers, Dennoo could select a subset of ads from a preexisting database/list of ad placement bids received from various advertisers. In one embodiment, an advertiser could place a bid for 1000 impressions for a given ad or a subset of ads. Such a bid cost will be based on eCPM, i.e. or the cost for displaying an ad or a subset of ads a total of 1000 times. In another embodiment, an advertiser could place a bid for 1000 effective impressions for a given ad or a subset of ads. Such a bid cost will be based on cost per mille effective impressions, i.e. the cost for effective impression of an ad or a subset of ads a total of 1000 times. The subset of ads could be generated such that the ads combined bid amount and play-time lengths meet both the eCPS bid amount and the AVT session length of the ad slot requesting ad placement. Furthermore, in the event the total play-time length is not given for an ad, Dennoo could play the ad to determine its total play-time.

FIG. 10C illustrates the ad bid placement process. Once the advertisers receive the ad placement request and the corresponding eCPM value, the advertisers place an ad placement bid to display their advertisement. Each bid includes the bid amount, which is generally the total of the eCPM value of the ad slot and the DSP fees. In FIG. 10C, Advertiser) places a bid of $0.33 and Advertiser5 a bid of $0.35 to their respective DSP. Dennoo selects ad bids from Advertiser2, 3, and 4 with bid amounts of $0.1, $0.2, and $0.4 respectively. Also, the advertisement from Advertiser2, 3, and 4 have a play-time length of 5 seconds, 10 seconds, and 20 seconds respectively. The other DSPs, after recovering their fee of $0.05 and $0.03 from each bid respectively, forward the ad placement bid of $0.3 each to an SSP.

Dennoo, based on the AVT value, combines the three ads into a single ad of 35 second play-time, where one ad begins when the other ends. This ensures that all the three ads get displayed in the single ad slot. Also, given that the eCPM value is known for the ad slot and the small likely premium advertisers are bidding, Dennoo can bid as high as $0.7, the ad slot's eCPS value, without paying any premium. In FIG. 10C, Dennoo places a bid of $0.4 for the combined single ad with the SSP while other DSPs have placed a bid of only $0.3. The SSP then determines the highest bid and forwards the advertisement of the winning bid to the Media/webpage requesting the ad and rejects the remaining bids. The bid from Dennoo, at $0.4, exceeds the bids from other DSPs and wins the bidding to place the three combined advertisements in the webpage requesting ad placement. Thus, not only was Dennoo able to win the bid by identifying undervalued ad slots, the media publishers benefited significantly from the increased bid amount from Dennoo.

### Illustration of Various Bidding Modes and Associated Conversion Schema

As illustrated above with reference to FIG. 4, the methods and systems disclosed herein also interoperate with conventional systems when, for example, connected via a DSP. The following sections disclose the various types of bidding schemes, including bidding schemes based on conventional parameters may be accepted and how conversion schema may then be applied to allow for interoperability.

### Bidding by CPC

Consider a scenario where the advertiser bids by CPC. The system will change the conditions of the advertisement to be shown, and from the collected data, find the condition that yields the best outcome/effect. For the measurement of effectiveness, the click through rate, for example, may be used. By increasing the effectiveness of the advertisement, the advertiser will enjoy better advertisement effect and return on investment, users will be shown ads of greater interest to them, and publishers will become more profitable. In embodiments, this information is continuously collected for learning purposes, and may be used at any point to determine the best advertisement fit for a given scenario. This allows for optimization of the advertisement placement based on present conditions, thus enhancing ROI for placement of the advertisement. In embodiments, machine learning (e.g., neural networks, fuzzy logic, or other machine learning techniques as understood by a person of ordinary skill in the art) may be utilized for such continuous learning. The conditions to be changed and tested include but are not limited to the following: length of ad; time of the day to show ad; position within the page view to deliver the ad; characteristics of the user to which the ad is shown; etc. The sample to be taken will be large enough to yield statistically significant results.

An example of the sampling can be as follows. The delivery time of the ad is x(seconds), the number of times that the ad is delivered is T (times), the cost per second of ad delivery is Cs (yen), the total cost is Ct (yen), then the following equation is true:

C=x×T×Cₛ (6)

Fixing C and solving for T, we obtain, for example, the following chart:

| | Number of times | | |
|---|---|---|---|
| Seconds of ad | that the ad is | Cost per second | |
| delivered | delivered | of ad delivery | Total cost |
| 10 | 2000 | 0.001 | 20 |
| 11 | 1818 | 0.001 | 20 |
| 12 | 1666 | 0.001 | 20 |
| 13 | 1538 | 0.001 | 20 |
| 14 | 1428 | 0.001 | 20 |
| 15 | 1333 | 0.001 | 20 |
| 16 | 1250 | 0.001 | 20 |
| 17 | 1176 | 0.001 | 20 |
| 18 | 1111 | 0.001 | 20 |
| 19 | 1052 | 0.001 | 20 |
| 20 | 1000 | 0.001 | 20 |
| . . . | | | |
| 30 | 666 | 0.001 | 20 |

When reflecting the results of the sampling and ad delivery, this can be based on the number of times the ad is delivered, or on the cost. If it is based on cost, the following example may be anticipated. From a single sampling or ad delivery, we know that the peak of clicks is at time t(seconds), and the distribution of the clicks is S, and another n deliveries are planned, the total cost of delivering k seconds is Ck. Ck can be renewed in the following manner:

When k is between −2S and 2S,

Ck+=Ck/n

When k is not between −2S and 2S,

Ck−=Ck/n]

If the peak of the clicks is at 18 seconds, the distribution (deviation) is 3, and there are 5 more deliveries left after the first deliver, the second delivery will be as follows:

| | Number of | | |
|---|---|---|---|
| Seconds of | times the ad | Cost per | |
| delivery | is delivered | second | Total cost |
| 10 | 1600 | 0.001 | 16 |
| 11 | 1454 | 0.001 | 16 |
| 12 | 1333 | 0.001 | 16 |
| 13 | 1846 | 0.001 | 24 |
| 14 | 1714 | 0.001 | 24 |
| 15 | 1600 | 0.001 | 24 |
| 16 | 1500 | 0.001 | 24 |
| 17 | 1411 | 0.001 | 24 |
| 18 | 1333 | 0.001 | 24 |
| 19 | 1263 | 0.001 | 24 |
| 20 | 1200 | 0.001 | 24 |
| . . . | | | |
| 30 | 533 | 0.001 | 16 |

Or, if the total number of deliveries is n, the cost Cki for the ith delivery of k seconds, with the median of seconds per click at a, will be:

Cki=Ck(i−1)+Ck(i−1)/n(−2σ<k<+2σ)

Cki=Ck(i−1)−Ck(i−1)/n(k<−2σ or k>+2σ)

### Bidding Based on CPM

When the advertiser is bidding by CPM, the system disclosed herein converts this bid into CPS. In conventional systems, if an advertiser bids by CPM, the price per 1000 page views was constant regardless of the number of clicks. In the system devised by this invention, advertisement slots are not sold by page views (PVs), so 1 PV is converted into 1 AV (ad view), and the amount to be charged will also be converted into CPS. For such bids, even if the CPM bid is the same, the CPS price may change according to the length of the ad. An interface in which the user enters the CPM cost, and then enters the number of seconds to deliver ads for each AV is entered would be expected, which will return in a real-time basis the number of AVs that this bid would amount to. Through such interface, advertisers can use the CPS logic and deliver ads accordingly while using a familiar eCPM-type method. An exemplary conversion formula comparing eCPM and eCPS was discussed above in, for example, equations (1) and (5).

### Bidding Based on Both CPS and CPC

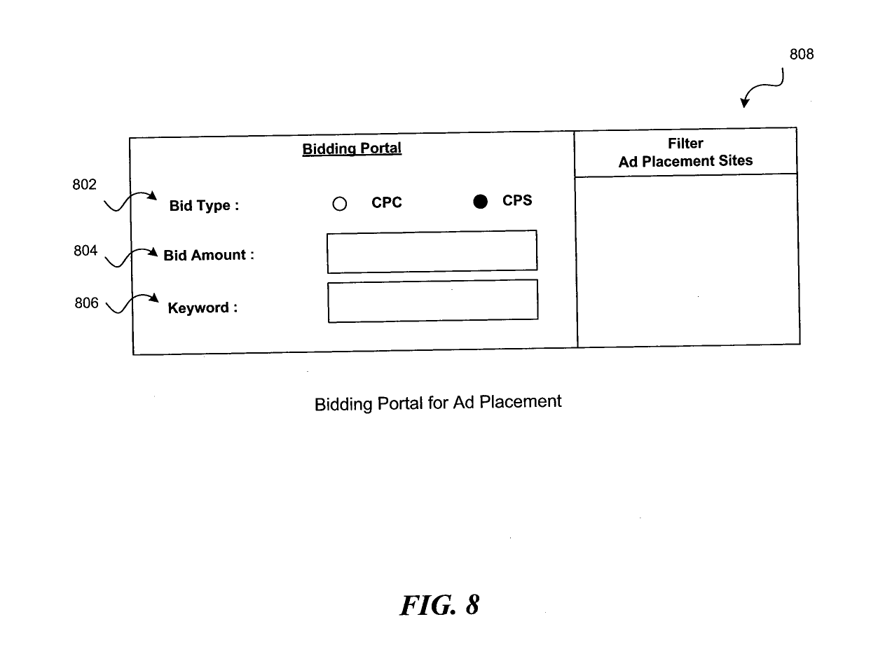

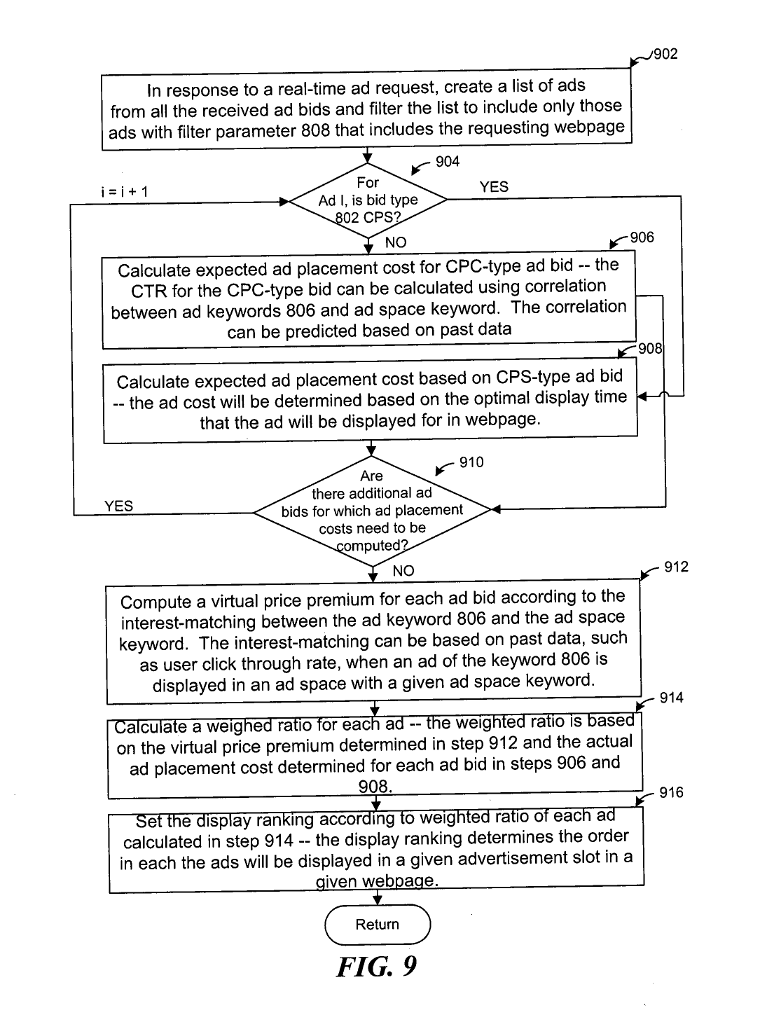

Advertisers may also bid using a combination of CPC and CPS. CPC is a way by which publishers guarantee to the advertisers the effect (e.g. click) of their ad. On the other hand, CPS is a way by which advertisers guarantee a certain amount of payment to the publisher. For example, limiting the CPC bid to 50% of the market “CPC-only” value, the “guarantee” can be shared equally between the media and the advertiser. As an example, consider an approach to bidding for ads based on both CPS and CPC. Of course, it is understood that such an approach may be extended to other types of advertisement bids and the bidding process may be expanded to include the additional bid types. However, for the sake of simplicity, we use the example illustrated in FIGS. 8 and 9. In this example, the ad(s) to be shown and their order will be determined based on real-time advertisement display requests. The purpose is to simultaneously consider both types of bids (CPC and CPS), and to optimize for a mixture of CPC and CPS bids. FIG. 8 illustrates a bidding portal 800 that advertisers utilize to place an ad bid. For each ad bid, the advertisers could set the following parameters: (1) bid type; (2) bid amount; (3) keyword; and (4) filter. The bid type parameter 802 allows the advertiser to choose the bidding process to be used with the ad. The bid type, for example, could either be CPS based or CPC based. CPS assumes that the ad is display (branding) advertisements. The bid amount parameter 804 is the amount of money the advertiser wants to spend as ad cost for the advertisement. Depending on the bid type, the bid amount could be either in price per click (for CPC-type ads) or price per second (for CPS-type ads).

The keyword parameter 806 is utilized by the advertiser to describe attributes of the advertisement that can be used to determine the most appropriate website and its users to advertise to. For example, an ad associated with keyword parameters, such as baseball, sale, jersey, hat, gloves, etc. together can be used to deduce that the ad could be for sale of baseball related accessories. Based on the deduction, the ad could then be placed in a sports news website that attracts sports fans whom are far more likely to purchase the baseball accessories than a user of a general news website. The filter parameter 808 allows the advertisers to choose the websites the ad will shown in. For example, the advertiser could search for top 10 websites based on web traffic and select a subset from these websites to place the ads in.

Once ad bids are placed, the method, as illustrated in FIG. 9, could be used to simultaneously consider both types of bids (CPC and CPS) in response to an ad placement request, and optimize ad placement for a mixture of CPC and CPS based bids. It is assumed that ad placements requests are already attributed by keywords based on the contents of the requesting website/page and/or user behavioral history. The keywords associated with the ad placement requests will be referred to as “ad space keyword” hereon after. In step 902 in FIG. 9, in response to a real-time ad request, create a list of ads from all the received ad bids and filter the list to include only those ads with filter parameter 808 that includes the requesting webpage.

In step 904, determine the bid type 802 for each of the ads on the filtered list and calculate the expected ad placement cost (i.e. bid amount) based on the bid type. For each bid, if the bid type is not CPS, step 906 calculates the expected ad placement cost based on CPC-type. In this embodiment, it is assumed that we are contemplating only two types of ad bid types, CPS and CPC. In general, there could be many different ad bid types and a similar decision process can be used to determine the ad bid type and compute the expected bid cost accordingly. For CPC bid type, the CTR can be calculated using the correlation between ad keywords 806 and the ad space keywords. The correlation can be predicted based on past data, such as user click through rate, when an ad of the keyword 806 is displayed in an ad space with a given ad space keyword. If there is insufficient data, the bid amount will be the bid amount.

In step 904, if the bid type is CPS, step 908 calculates the expected ad placement cost based on CPS-type ad bid. The ad cost will be determined based on the optimal display time that the ad will be displayed for in webpage. For a given ad, the optimal display time can be calculated separately, for e.g., based on the likely length of the ad that will be sufficient to generate a user click of the ad. The likely length of the ad needed for optimal display time can be determined based on the past data, such as previous display lengths of ad and the ad timeline at which user clicks were generated for the ad. In step 910, determine if there are additional ad bids for which ad placement costs need to be computed. If yes, repeat steps 904 through 908 as required.

Once the ad placement costs for all the ad bids have been computed, step 912 computes a virtual price premium for each ad bid according to the interest-matching between the ad keyword 806 and the ad space keyword. The interest-matching can be based on past data, such as user click through rate, when an ad of the keyword 806 is displayed in an ad space with a given ad space keyword. Step 914 calculates a weighted ratio for each ad. The weighted ratio is based on the virtual price premium determined in step 912 and the actual ad placement cost determined for each ad bid in steps 906 and 908. In step 916, the display ranking, according to which the ads will be placed in a ad requesting webpage, will be determined based on the weighted ratio of each ad calculated in step 914. Thus, the ad(s) to be shown and theft order will be determined based real-time, while simultaneously considering both types of bids (CPC and CPS). Additionally, through interest matching of free keywords, a fair and natural auction (as compared to the arbitrary nature of interest categories) will be realized.

### Computing Advertising Indices

The index for the conventional method of advertisement in which the effective price of 1000 impressions is eCPM, and the indices devised by techniques introduced herein (e.g., in which CPS and CPC are designated in combination) for branding and direct response are “Branding plus Direct Response CPS (bdCPS)” and “Branding Plus Direct Response CPC (bdCPC)”, Non-limiting examples of computing various advertising indices, as contemplated by the CPS methodologies introduced herein, are now presented.

The unit of advertisement is the general term “Advertisement”, or its shortened form, “Ad(s)”.

If the Ad is displayed even for an instant, that display is considered an “Ad View (AV)”, and corresponds to the index “Page View (PV)” for the displaying of websites, etc. For example, if an advertisement is shown 1000 times, that would be counted as 1000 Ad Views (AVs).

Next, the inherent length of a specific advertisement (i.e. the length of an advertisement movie) is referred to as the “Ad Length (AL)”. If the advertiser submits an advertisement video that has a length of 15 seconds, the AL is 15 seconds regardless of the users' actions or display times.

The specific time that an ad has been shown on the screen is referred to as the “Ad View Length (AVL)”. If a user jumps to a different website after 8 seconds of a 15-second ad has been shown, the AL is 15 seconds, but the AVL is 8 seconds.

When an ad or multiple ads have been shown for a certain number of times, the average of the AVLs is referred to as the “Average Ad View Length (AAVL),”

The click rate for a certain number of AVs shall be referred to as the “Ad View Click Rate (AVCR)”.

By calculating the cost necessary for an ad to be clicked once by the user, in the case of bdCPC×bdCPS, the cost when bCPS is used can be deducted and a recommendation may be made for bCPS.

The cost between clicks is bdCPS×SPC+bdCPC, and therefore bCPS must be the cost between clicks/SPC.

bdCPS×SPC+bdCPC/SPC=bCPS×SPC (7)

Average Ad Length (AAL) is:

$$AAL = \frac{{\sum }_{n} AAVLn}{n} \qquad ( 8 )$$

In embodiments, We can assume that PV and AV have equivalent values. The conventional system using eCPM sells all PVs over, for example, 3 seconds long at the same price, regardless of the length of the video. This is one of the fundamental flaws of CPM.

The relationship between AV and PV are as shown below:

$$AV = PV \times APVL \times 1000 \times \frac{n}{{\sum }_{n} AAVLn} \qquad ( 9 )$$

where, when a number of pages have been viewed for a total page view length of x seconds, Average Page View Length (APVL) is a simple average of page view length, i.e. APVL=(Sum of page view length)/(Number of Page Views).

In one embodiment, AAL could be an simple average of ad lengths, i.e. AAL=(Sum of Ad Lengths)/(Number of Ads). In another embodiment, AAL could be a weighted average of ad lengths, i.e. AAL=(weighted sum of Ad Lengths)/(Number of Ads)”. Thus, in general terms, AAL is a function of ad lengths, i.e. AAL=f(Ad lengths).

Here, the relationship between CTR in conventional eCPM systems and AVCR in the system as contemplated herein is defined, and this is used to calculate the number of clicks in 1000 PVs and the clicking cost for 1000 PVs.

CTR=the number of clicks/PV

AVCR=the number of clicks/AV

in conventional eCPM systems, the clicking cost of 1000 PV=1000×CTR×CPC. On the other hand, in the eCPS system using bdCPC×bdCPS, the following relationships are true:

$$the number of clicks in 1000 PV = 1000 \times ( AV / PV ) \times AVCR \\ the clicking cost for 1000 PVs = 1000 \times ( AV / PV ) \times AVCR \\ Thus , \\ the number of clicks in 1000 PV = 1000 \times CTR \times CPC \times {10}^{3} \times APVL \times {10}^{3} \times \frac{n}{{\sum }_{n} {AAVL}_{n}} \times AVCR \times bCPC + bdCPS \times SPC \times {10}^{3} \times APVL \times {10}^{3} \times \frac{n}{{\sum }_{n} {AAVL}_{n}} \times AVCR \qquad ( 11 )$$

Now, bCPS in eCPS can be represented by the clicking cost in 1000 PVs, and a connection can be made with bdCPS×bdCPC in eCPS.

AVCR=the number of clicks/AV

Seconds for 1000PVs=PAVL×1000

clicking cost for 1000PVs=1000×(AV/PV)×AVCR×bCPC+bdCPS×SPC×100×(AV/PV)×AVCR

Then,

the clicking cost for, 1000PVs/seconds for 1000PV=recommended bCPS

This means that:

$$\begin{matrix}bCPS = {10}^{3} \times \frac{n}{{\sum }_{n} {AAVL}_{n}} \times \frac{clicks}{AV} \times bCPC + bdCPS \times SPC \times {10}^{3} \times \frac{n}{{\sum }_{n} {AAVL}_{n}} \times \frac{clicks}{AV} \\ Thus \text{:} & ( 12 ) \\ bCPS = \frac{bdCPC \times clicks + bdCPS \times SPC \times clicks}{PV \times APVL} \\ bCPS = \frac{bdCPC + bdCPS \times SPC}{APVL} \times CTR & ( 13 )\end{matrix}$$

This makes a connection between bCPS and bdCPS×bdCPC in eCPS. eCPS indicators may also be computed as:

eCPS=(bdCPC+bdCPS×SPC)×CTR×1000 (14)

In embodiments, eCPS is the eCPM that can be expected for the publisher in the system that is devised using the techniques introduced herein, and if this value is larger than the eCPM value for conventional technology, it can be expected that the publisher/media will yield a higher revenue. This would allow for market value lost by conventional technology to be rediscovered, the underrated value to be evaluated appropriately, and the entire market to be revitalized,

### Determining Order of Priority for Advertisements

Based on the above-discussed ability to obtain eCPS value, the “order of priority for advertisements” can be determined. Here, the expected CTR or the SPC, eCPS, interest matching score, the quality of ad creativeness or the quality of the ad landing page, etc. are indices that are the basis when determining the “quality of the advertisement”, and the “order of priority which takes the quality of advertisements into considerations”, can be calculated, for example, as below:

$$S ( u , k ) = {\sum }_{n} {C}_{n} ( u , k ) {W}_{n} ( u , k ) \qquad ( 15 )$$

Here, S is the total quality score, u is the advertiser, k is the keyword that is the target of the advertisement, Cn is a set of elements that compose the quality and Wn is the weighted value for each of these elements. The above equation is merely an example and the formula for calculated the quality of advertisements need not be limited to the above equation.

Further, the quality of advertisements in the device devised by this invention need not be based on the Seconds per Click (SPC) index, but for example on the Ad View Click Rate (AVCR). When this is the case,

AVCR=Number of Clicks/Number of Effective Distributions of the Advertisement

In embodiments, the systems described herein may be equipped with a mechanism to match keywords that are set for advertisements to become targets for distribution and keywords or the equivalents thereof that users have entered into a webpage or keywords that have been extracted from web pages viewed by the user. The mechanism to calculate the fit of these keywords can be as explained below.

The goodness of fit for a pair of arbitrary keywords k1 and k2 can appropriately be calculated by the semantic similarity of the pair. For an area such as web advertisements in which new topics are continuously born and these newly born topics can be of high importance, it is essential to deal with unknown keywords. Therefore, Sh (k1, K2)=[Distance within the class] if the keyword pair is known and the existing class relations can be used semantically. If this is not the case, the distance Sq (k1, K2) in a keyword graph dynamically composed from the Co-occurrence frequency can be used. The total goodness of match can be calculated with a weighted sum S(k1,k2)=h Sh(k1,k2)+g Sg(k1,k2). Here, for an unknown keyword, the most similar known keyword S (k1, K2) can be obtained and used as the alternative keyword by calculating the distance between character strings

Further, when using advertisements of variable lengths such as those devised by the techniques described herein, the switching of advertisements are based not on page transition but on time, and additionally, they can switch upon page transition as shown in FIG. 5. In the case where switching occurs upon page transition, because it would be assumed that a new series of advertisement display occurs upon switching pages, the possibility that the same advertisement will be shown more than once to the same user will become higher. On the other hand, if advertisements are distributed by the device devised by this invention rather than based on page transition, if it is assumed that the same series of advertisement display is continuing, a single series of advertisement display becomes longer, and the possibility that the same advertisement will be shown more than once will decrease, but the possibility that a low-priority advertisement is shown will become higher.

Here, several indices can be used to determine the order of priority in displaying advertisements. Some examples of events or matters that may be the basis of these indices are as illustrated in the chart below.

Elements for determining the order of priority for displaying
advertisements

| | |
|---|---|
| Obtained from | Target for displaying the advertisement (keywords, |
| the DSP | attribution, etc) |
| | Bidding prices (CPC; CPS) |
| | Length of the Advertisement (AD Length AL) |
| | Size of the Advertisement |
| Obtained from | Length of time that the ad was actually displayed (Ad View |
| the SSP | Length AVL) |
| | (Click Through Rate, CTR) |
| | the time necessary for a click to occur (Seconds per Click, |
| | SPC) the total number of seconds until a conversion is |
| | reached (Seconds Per Action, SPA) |
| | Attribution of contents and users |
| Obtained by | The goodness of fit for the attribution of the contents on |
| the device | which and users to which the advertisement is show, |
| | and the keywords and attributions that advertisements |
| | targets for display |
| | Quality of the pages to which jumps are made upon |
| | clicking advertisements |
| devised by this | Goodness of fit between the advertisement and the |
| invention | keywords that the advertisement targets for display |

With these events and matters considered, indices to determine the order of priority to display advertisements can be devised as below, and by determining the order of priority to display advertisements based on these indices, the value of displaying advertisements can be increased

Examples of Methods to Determine Order of priority of Advertisement Display

Indices to determine the order of priority to display advertisements can be devised as illustrated using illustrative examples below. By determining the order of priority to display advertisements based on these indices, the value of displaying advertisements may be increased, allowing for a more competitive and efficient advertising paradigm.

For a page p that the user u is viewing, a calculation of the weighted order of priority of display for advertisement group aj may need to be computed. In other words, the function w (aⱼ, u (p)), which calculates the weight, will express the algorithm for the entire calculation. Here, u (p) expresses the profile of user u when page p is viewed, including the viewing history.

When calculating using the degree of similarity between keywords, calculations are executed by expressing each user profile and advertisement as a set of attributed keywords Ku and Ka. In other words, w(aⱼ, u(p))=w(Kaⱼ,Ku). The degree of similarity between an arbitrary keyword pair of k1 and k2 can be calculated by the method abovementioned. Using this, the order of priority for displaying the advertisement can be obtained by sorting for

$$w ( {a}_{i} , u ( p ) ) = {\sum }_{m , n} {c}_{m} {c}_{n} s ( {k}_{m} , {k}_{n} ) \qquad ( 16 )$$

Here, cₘ is the coefficient is based on the attribute type of the keyword, and by adjusting this coefficient, the attribute value of both the DSP and the SSP may be determined.

Time-Variable CPS Based on User Interaction with Advertisement

In at least some embodiments as disclosed herein, the Cost per Second (CPS) of an advertisement can be varied within a given advertisement. In one instance, the CPS of an advertisement can be varied for each image frame in the advertisement. In another instance, the CPS of an advertisement can be varied for each section of the advertisement, where each section is defined by a fixed length of time. In embodiments, the CPS value for a given section of the advertisement can be determined based on a detected user's interaction with the displayed advertisement. In embodiments, the CPS value for a given section of the advertisement can be determined based on a user's interaction within a publisher page where the advertisement is displayed. For example, a user interaction could be a user click within the displayed advertisement or the publisher page, a pause, play or rewinding of the displayed advertisement, a data input by the user within the advertisement or the publisher page, etc.

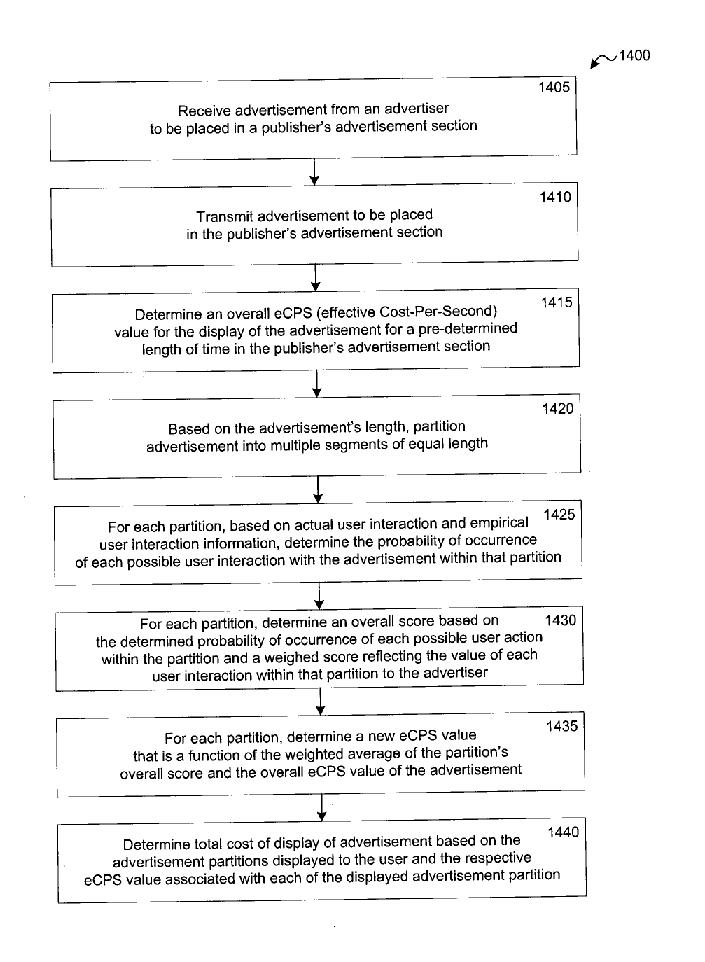

FIG. 14 illustrates the time-variable CPS process. In step 1405, the ad platform requests and receives an advertisement from an advertiser to be placed in a publisher's advertisement section. In step 1410, the ad platform transmits the advertisement to be placed in the publisher's advertisement section. In step 1415, the ad platform determines an overall eCPS (effective Cost-Per-Second) value for the display of the entire length of the advertisement. In step 1420, based on the advertisement's length, the ad platform partitions the advertisement into multiple segments of equal length. Let us assume that a certain advertisement has a creative of length L, and an eCPS value for the entire length of the advertisement of α₀. The advertisement is of length L is partitioned into J segments, where segment Iⱼ timeframe is defined as:

Iⱼ=[(j−1)L/J,jL/J)], (j=1, . . . , J) (17)

where, each segment is of the same length.

In step 1425, for each partition, based on actual user interaction and empirical user interaction information, the ad platform determines the probability of occurrence of each possible user interaction with the advertisement within that partition. Further, the ad platform utilizes a weighed score associated with each user interaction, where the weighted score reflects the value of each user interaction within that partition to the advertiser. Let A=(a₁; a₂; . . . ; a_{K}) be the set of users' interactions under consideration, and let s_{K} be the score of interaction a_{K} respectively. Further, in some embodiments, lets assume that i<j=>sᵢ<sⱼ, where interactions which share the same score are considered identical.

For example, the ad platform estimates the probability pₖ^{(j)} of an occurrence of response aₖ in the jth segment Iⱼ. Given data D={(aₖ₍ₙ₎,t₍ₙ₎)}^{N}=1 of users' responses and time they occurred, the ad platform estimates pₖ^{(j)} by the following formula:

$${p}_{k}^{( j )} = \frac{{n}_{jk} + {n}_{kj}^{*}}{{N}_{j} + {\sum }_{k = 1}^{K} {n}_{kj}^{*}} \qquad ( 18 )$$

where, nⱼₖ is the number of occurrences of response aₖ, nₖⱼ* denotes some prior knowledge about probability of response aₖ occurring in segment Iⱼ.

Further, Nⱼ is the total number of responses which occurred in segment Iⱼ or later and is defined by the following equation:

$${N}_{j} = {\sum }_{{j}^{′} = j}^{J} {\sum }_{k = 1}^{K} {n}_{{kj}^{′}} \qquad ( 19 )$$

In step 1430, for each partition, the ad platform determines an overall score based on the determined probability of occurrence of each possible user action within the segment and the weighed score reflecting the value of each user interaction within that segment to the advertiser. In one embodiment, the ad platform calculates the expected score Sⱼ of segment Iⱼ by equation Sⱼ=Σₖ sₖpₖ.

In step 1435, the ad platform, for each partition, determines a new eCPS value that is a function of the weighted average of the partition's overall score and the overall eCPS value of the advertisement. In embodiments, the ad platform, calculates the adjusted CPS c(t) (i.e. eCPS) in terms of pₖ^{(j)} and Sⱼ. In embodiments, we assume Sⱼ>0. In cases where Sⱼ<0, we can add in some constant so that Sⱼ>0 holds. Here, CPS c(t) (i.e. eCPS) in terms of pₖ^{(j)} and Sⱼ is defined as:

$${c}_{j} = \frac{{S}_{j}}{{\sum }_{j = 1}^{J} {S}_{j}} {α}_{0} J \qquad ( 20 )$$

Further, we determine the form of CPS c(t) for each partition using Sⱼ such that the values cⱼ preserves eCPM for the advertiser, where it is assumed that c(t) takes constant cⱼ over each segment Iⱼ;

$${α}_{0} L = {\sum }_{j = 1}^{J} {c}_{j} \frac{L}{J} \qquad ( 21 )$$

In step 1440, the ad platform determines the total cost of displaying the advertisement based on the advertisement partitions displayed to the user and the respective CPS c(t) (i.e. eCPS value) associated with each of the displayed advertisement partition. The ad platform, thus, produces a piecewise constant CPS c(t) for the length of the advertisement.

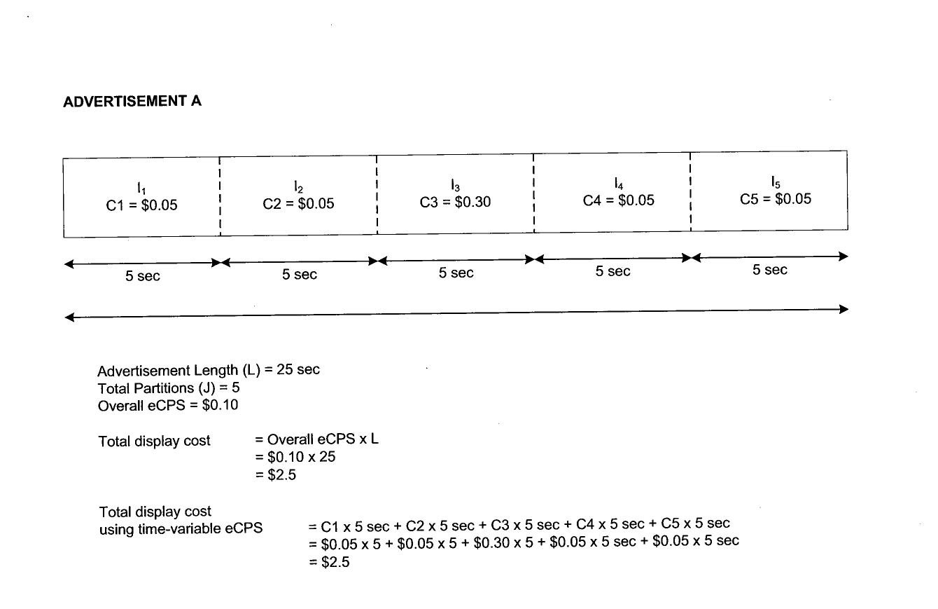

FIG. 15 illustrates an advertisement with five partitions for which a piece-wise constant CPS c(t) is computed by the ad platform using the above described embodiment. Here, J=5, where the advertisement is partitioned into 5 segments of 5 seconds each, where the advertisement is of length L=25 seconds. Also, let CPS α₀=$0.10 eCPS, such that the overall cost of displaying the entire ad of length L of 25 seconds is $2.5. Lets say overall score for each segment, based in the probability of occurrence of various actions and their relative value of those actions to the advertiser, is S1=1, S2=1, S3=6, S4=1, S5=1.

Based on equation 20, C1=(1/10)*0.1*5=$0.05; C2=(1/10)*$0.1*5=$0.05; C3=(6/10)*$0.1*5=$0.30; C4=(1/10)*$0.1=$0.05; C5=(1/10)*$0.1*5=$0.05.

Based on equation 21, we have CPS α₀*L=$0.1 eCPS*25 sec=$2.5=(0.05+0.05+0.3+0.05+0.05)25/5=$0.5*25/5=$2.5. Thus, the ad platform produces a piece-wise CPS c(t) of $0.05, $0.05, $0.3, $0.05 and $0.05 for segments I₁, I₂, I₃, I₄ and I₅ respectively. In embodiments, when only segments I₁, I₂ and I₃ are displayed to the user, the overall cost of displaying the ad is length of each segment×their respective CPS c(t) value. Here, 5*$0.05+5*$0.05+5*$0.3=$2.00 (compared to $1.5 for an advertisement with an overall constant eCPS of $0.1 for the 15 seconds over the 3 segments).

### “Keep” Advertisement and Tracking Effective Impression and Relevancy of Such Kept Advertisement

In the internet market as of today, the internet has become a “media” with the introduction of social media such as Facebook, Twitter, etc. An aspect of the technology introduced herein is an ability to launch a cost-effective ad campaign for a limited period of time in the Internet, and especially the social media such as Facebook, Twitter, etc. Unlike the conventional eCPM based ad campaigns, where advertisers are charged per display, the eCPS based model charges the advertisers only in the event of an effective impression. Further, social media such as Facebook offer users the ability to save and share content from across the web with other users. One such content could be advertisements. For example, ads during Super Bowl are some of the most watched content on the web, where users forward and share these ads repeatedly. In such a scenario, the current system of charging advertisers based only on display of ads in the media publishers' website fails to fully capture the effective impressions achieved from each replay of the saved ads by the users.

In embodiments of the CPS based advertisement platform, the platform allows the advertisers and the media publishers to track such saved ads and count the effective impressions from replays towards the determination of final cost of the ad campaign. Such a platform not only provides advertisers a more complete picture of the effect of the ad campaign, it also allows the media publishers to fully monetize their user base, when such users share and re-view the saved ads. In embodiments of the CPS based advertisement platform, a “keep” button can be added to the ads or to a user's user page to allow the user to save and collect ads. The user can later view such “kept” ads from the user's user page. Further, the “keep” page will be open to other users who can also watch and share these ads.

In embodiments, such “kept” ads will be tracked by the CPS based advertisement platform. So, every time the users watch these “kept” ads, the CPS based advertisement platform will charge the advertisers using a CPS cost basis (i.e. based on consideration such as mouse roll-over time, sound-on time and other user engagements). The ads will disappear from the user's “keep” page once the ad campaign finishes. In embodiment, the platform tracks the number of times the users pressed the “keep” button. Further, the platform could track the users on media publishers such as Facebook and Twitter. The platform could monitor the sites for number of “Like” collected, tweet mentions, etc. In embodiments, the advertisers could be provided with metrics such as “Like” counts, “Keep” counts, tweets, etc. to help enable advertisers to better gauge user interests. Further, the advertisers could be charged for ads based on the ad campaign's effectiveness, where such determination of effectiveness is based on the analysis of “Like” counts, “Keep” counts, tweets, etc.

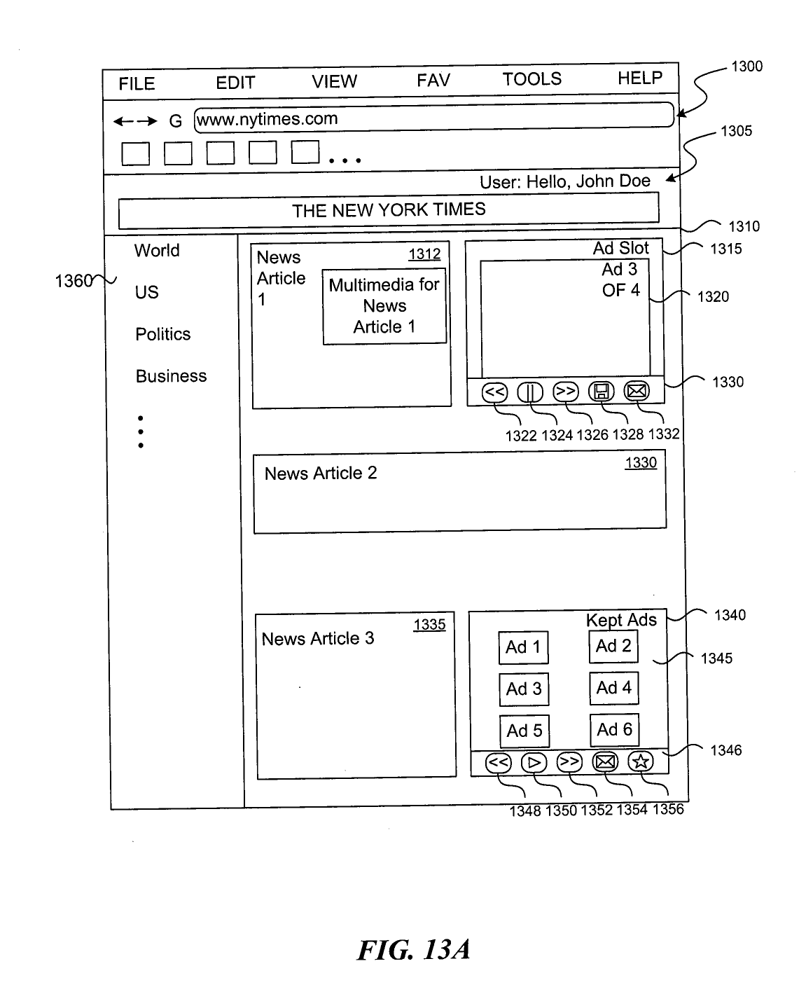

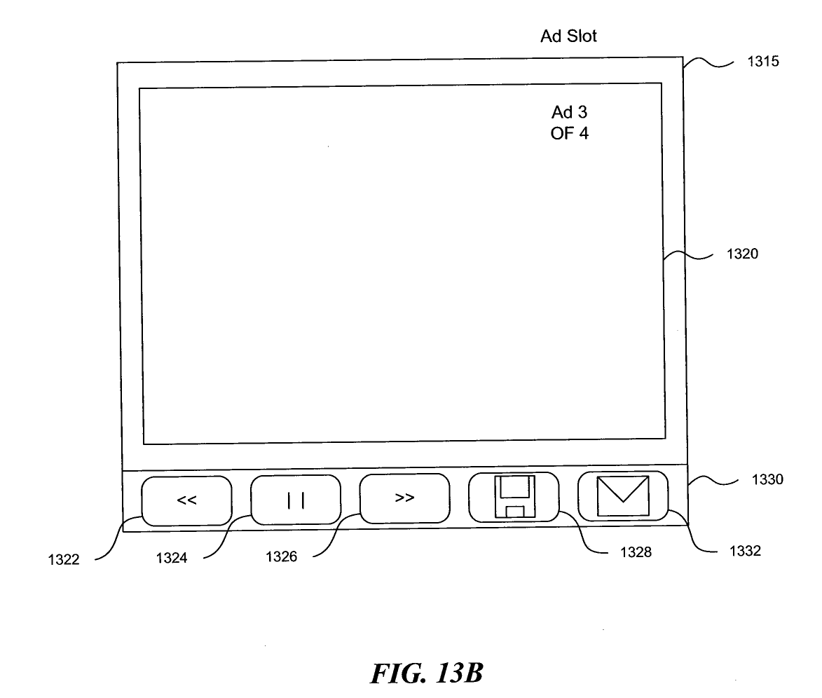

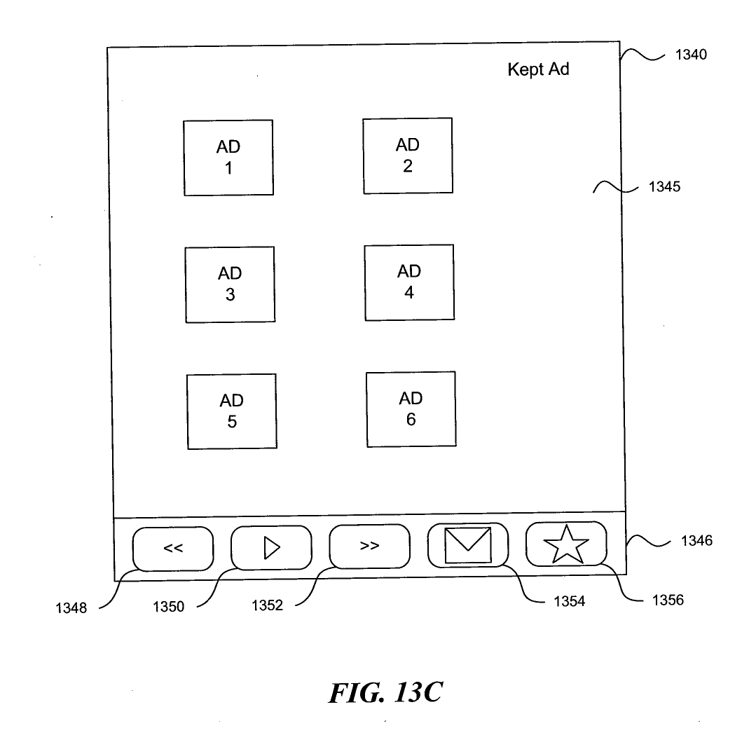

FIGS. 13A, 13B, and 13C illustrate one embodiment where the above described “Keep” feature is practiced. The illustrative embodiment is merely meant to describe one embodiment where the “Keep” feature is practiced and is not meant to be a limiting embodiment of the invention in any sense. There are other embodiments that one of ordinary skill in the art can quickly recognize and practice the above described “Keep” feature in for ad tracking, sharing and improving revenue realization for publishers, etc. FIG. 13A illustrates a publisher's website “www.nytimes.com” 1300 being viewed through a web browser, where an ad slot 1315 is available in the to publisher's website 1300 to display advertisement amongst other publisher news content 1312, 1330, 1335 and 1360 and a “Kept Ads” section 1340 to view any previously kept ads. In one embodiment, the website 1300 includes user accounts that a visitor to the website 1300 can utilize to customize the web pages in the website 1300. In FIG. 13A, a visitor has logged into the website 1300 using the user name John Doe 1305, where the user name is displayed at the top of the current web page 1310. Every time the visitor logs into their user account, the website 1300 loads their preferences and any visitor specific content they have bookmarked or saved into their user account. In another embodiment, the website 1300 can utilize cookies to track the visitor and visitor's preferences and load the visitor specific content to the website every time the visitor visits the website without requiring the visitor to setup a user account or log into such a previously setup user account.

In one embodiment, the ad slot 1315 in the web page 1310 is used to display advertisements, where the ad slot includes a integrated ad control bar 1330. The ad control bar 1330 includes a rewind button 1322, a play/pause button 1324, a forward button 1326, a keep button 1328 and a share button 1332. When a visitor/user wishes to replay a previously displayed advertisement or restart a currently playing advertisement, the user can use the ad control bar 1330 integrated within the ad slot 1315 to transition to any of the previously displayed advertisements. For example, when the user clicks the rewind button 1322 once in the middle of the display of advertisement 3, the ad slot 1315 will rewind the ad back to the beginning of advertisement 3 and replay. When the user clicks the rewind button 1322 twice in the middle of the display of advertisement 3, the ad slot 1315 will rewind the ad back to the beginning of advertisement 2 and replay. Once the user has watched the replay of an advertisement, the user may wish to skip any intermediate advertisement between the replayed advertisement and the advertisement that is yet to be fully served at least once to the user and return to fully watch the advertisement that is yet to be fully served. For example, after the user has watched advertisement 1 the user can use the navigation bar 330 to navigate to either advertisement 2 or 3. The user could click on the forward button 1326 once to transition to advertisement 2 at any point during the viewing of advertisement 1. Similar to the rewind button 1322, clicking the forward button 1326 twice will transition the user to advertisement 3 at any point during the viewing of advertisement 1. The play/pause button 1324 allows the user to start playing an advertisement or pause a currently playing advertisement. In one instance, the share button 1332 allows a user to share the currently playing advertisement in the ad slot 1315 with another user. In one instance, the user could forward a www link, such as a link to the advertisement in the advertiser's webpage, to the email address of another user. The other user could click on the www link in the email to go to the appropriate webpage, where the advertisement is automatically displayed when the webpage is loaded in the other user's web browser.

In one embodiment, when the user wishes to save any of the ads served through the ad slot 1315, the user can click the “Keep” button 1328 to store a copy of any currently displayed advertisement in the ad slot 1315 to a content repository associated with the user account John Doe in the website 1300. In another embodiment, the kept ad can be stored in the user's computer and retrieved and displayed by a server associated with the website 1300 when the user next visits the website 1300. Whenever the user specific content is loaded into the website 1300, a server associated with the website 1300 could track and populate the Kept Ads slot 1340 with the previously saved ads. Each previously saved ad could be displayed in the Kept Ads slot 1340 as list of icons 1345, where clicking on one of the displayed icons 1345 using a mouse could replay the associated advertisement in the ad slot 1315. In another embodiment, the advertisement associated with the icons 1345 could be replayed in a media player, such as Windows Media Player, Apple Quicktime player, etc., previously loaded into the user's computer or mobile device.

In another embodiment, the user could utilize the navigation bar 1346 in the Kept Ads slot 1340 to navigate between the list of icons 1345 and replay any of the stored ads. For example, the backward 1348 and forward 1352 button can be used to navigate between the various icons 1345 displayed in the Kept Ads slot 1340 and the play/pause button 1350 to replay the advertisement currently associated with the selected icon from the icon list 1345. The share button 1354 allows a user to share the currently selected advertisement from the list 1345 with another user. In one instance, the user could forward a www link, such as a link to the advertisement in the advertiser's webpage, to the email address of another user. The other user could click on the www link in the email to go to the appropriate webpage where the advertisement is automatically displayed when the webpage is loaded in the other user's web browser.

In another embodiment, the “Keep” button 1328 can act to bookmark a currently playing advertisement that appealed to the user, where the bookmark is tracked by the ad platform that served the bookmarked advertisement. In one instance, the ad platform manages the Kept Ads slot 1340 and populates the Kept Ads slot 1340 with icons 1345 that act as links to each of the kept ads. In one instance, the links are associated with copies of the kept advertisements that are stored in servers that are part of the ad platform. When a user clicks on one of the displayed icons 1345 using a mouse, the associated advertisement is loaded from the ad platform server into the ad slot 1315 and replayed in the ad slot 1315. In one embodiment, the advertisement associated with the icons 1345 could be replayed in a media player, such as Windows Media Player, Apple Quicktime player, etc., previously loaded into the user's computer or mobile device.

In another embodiment, the user can utilize the navigation bar 1346 in the Kept Ads slot 1340 to navigate between the list of icons 1345 and replay any of the stored ads. For example, the backward 1348 and forward 1352 button can be used to navigate between the various icons 1345 displayed in the Kept Ads slot 1340 and the play/pause button 1350 to replay the advertisement currently associated with the selected icon from the icon list 1345. The share button 1354 allows a user to share the currently selected advertisement from the list 1345 with another user. In one instance, the user could forward a www link, such as a link to the advertisement in the advertiser's webpage, to the email address of another user. The other user could click on the www link in the email to go to the appropriate webpage where the advertisement is automatically displayed when the webpage is loaded in the other user's web browser. In one embodiment, the user could utilize the rate button 1356 to rate the replayed advertisement. The ad platform could capture the user provided ratings using a cookie.

In one embodiment of the CPS advertisement platform, the platform utilizes the cookies to track such kept ads and count the effective impressions from replays towards the determination of final cost of the ad campaign. Such a platform not only provides advertisers a more complete picture of the effect of the ad campaign, it also allows the media publishers to fully monetize their user base, when such users share and re-view the saved ads. So, every time the users watch these “kept” ads, the CPS based advertisement platform will charge the advertisers using a CPS cost basis (i.e. based on consideration such as mouse roll-over time, sound-on time and other user engagements). In one embodiment, the kept ads could be part of an ad campaign with a limited budget. Every time the ad is successfully displayed, the ad budget is reduced by the cost of successfully serving the ad. In another embodiment, the ads will disappear from the user's “Kept Ads” slot 1340 once the ad campaign finishes or the ad campaign budget runs out. In embodiment, the platform tracks the number of times the users pressed the “keep” button. In another embodiment, the platform could track the users on social media publishers such as Facebook and Twitter and collects metrics related to social media that help better track the kept ads within the social media. For an advertisement displayed within a social media publisher, the platform could monitor the sites for number of “Like” collected, tweet mentions, etc for the displayed advertisement. In embodiments, the advertisers could be provided with metrics such as “Like” counts, “Keep” counts, tweets, etc. to help enable advertisers to better gauge user interests. Further, the advertisers could be charged for ads based on the ad campaign's effectiveness, where such determination of effectiveness is based on the analysis of “Like” counts, “Keep” counts, tweets, etc.

Upon reading this disclosure, those of skill in the art will appreciate still additional alternative structural and functional designs for a system and a process for keeping ads and tracking such kept ads through the disclosed principles herein. Thus, while particular embodiments and applications have been illustrated and described, t is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

### Gross Rating Point (GRP) for Comparing Ad Effectiveness in Different Media

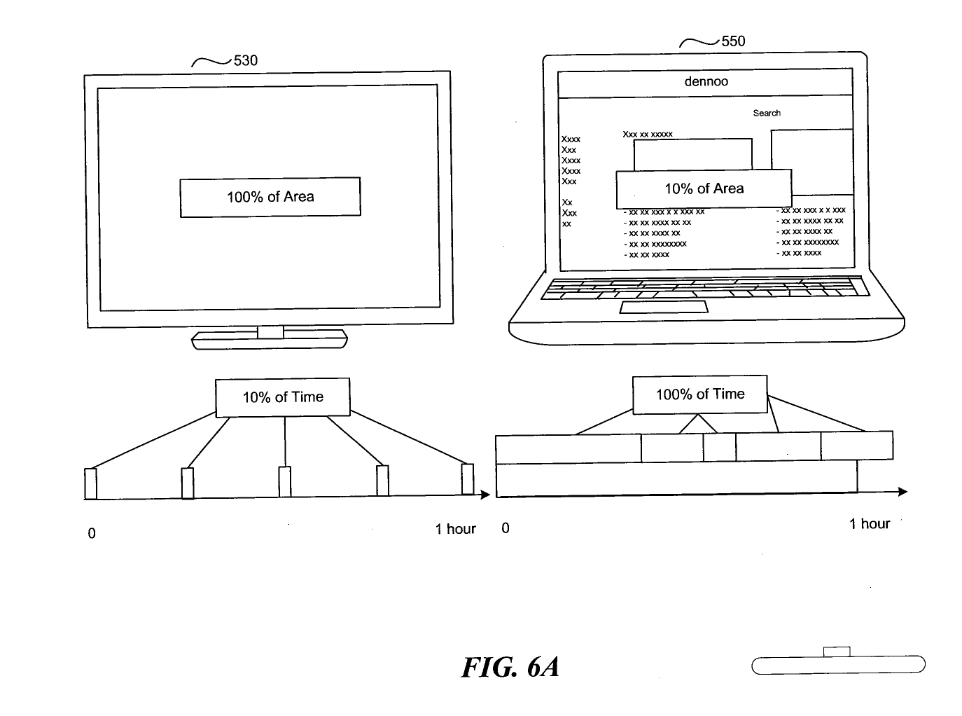

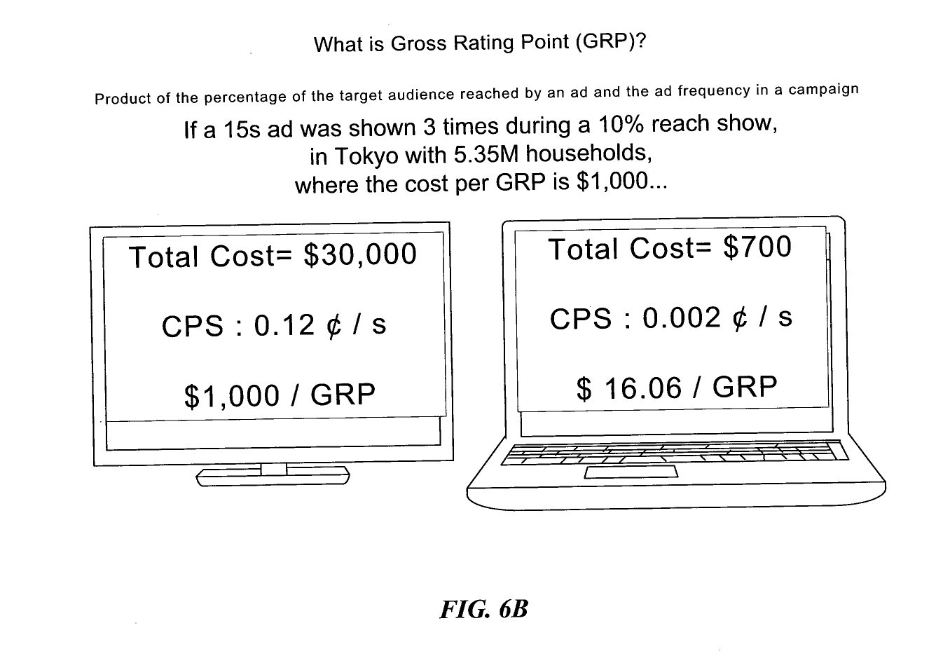

Another aspect of the technology introduced herein is an ability to identify and appreciate the efficacy of an ad campaign, especially when the same advertisements are offered through different media. As an example, consider a comparison of a branding-type ad shown as a regular TV advertisement and when shown in web media in conjunction with the CPS-based technology disclosed herein. Of course, it is understood that such comparison may extend to other types of advertisements (e.g., search based advertisements) and comparisons may be between or among various different types of media. However, for the sake of simplicity, we use the example illustrated in FIGS. 6A-6B.

Here, as illustrated in FIG. 6A, the same advertisement is displayed using a TV 530 and also using a CPS-backed ad campaign. In the case of the TV advertisement 530, the ad clip is shown, for example, every 10 minutes during an hour for 20 seconds each time. However, the area covered by the advertisement is 100% (meaning it occupies the full screen). In the case of a branding e-commerce campaign 550, the advertisement is shown only at 10% of the area of the screen, but is shown continuously for the entire hour (assuming in this example that this is the only advertiser and has bid in a CPS manner for advertising through the entire page session). Here, the ad impression, i.e., the effective impression of the ad can be computed as the area multiplied by time of display of the ad. In this example, the effective impression for the two types of media is roughly the same—with the TV campaign showing the ad in a larger area, but in overall shorter duration, and the Internet campaign showing the ad in a smaller area, but in overall longer duration. Accordingly, given the approximately equal impression values, one would expect cost of advertising to be the same. However, that is not the case, and cost of advertising in a relative sense needs to be determined.

Since it is difficult to compare directly the cost of the campaigns, a Gross Rating Point (GRP) manner of comparison is introduced. Here, GRP is defined as the product of the percentage of target audience reached by an ad (percentage of population that saw the ad) and the ad frequency in the campaign. Accordingly, in the above example, as illustrated in FIG. 6B, if a 15 s ad was shown three times during a 10% reach show, and a particular demographic has 5.35 million households, where the cost per GRP in the TV campaign is $1000. As can be seen, the total cost using the GRP technique for the TV campaign is at $30,000. On the other hand, in the internet based campaign, the CPS bid by the advertiser is effectively 0.0002 cents per second. Using similar conditions, the cost is $700 for the above example. That is, for similar ad impressions, the CPS-backed Internet campaign is substantially less expensive relative to the TV counterpart. This computation and comparison has two benefits: it allows an advertiser to readily perceive the difference in cost of campaigning in different media to obtain similar ad impressions; and it also allows an advertiser to readily appreciate the advantage of using CPS-backed technology to achieve similar efficacy while reducing cost of advertising.

### Key Performance Indicators (KPI) for Comparing Ad Effectiveness

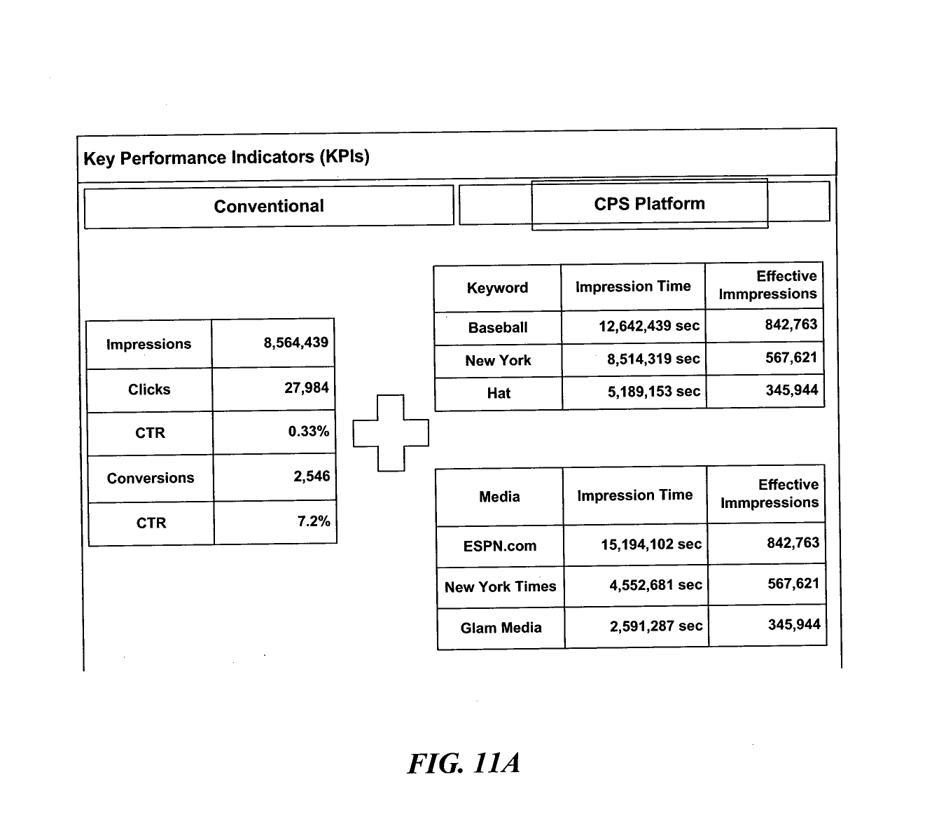

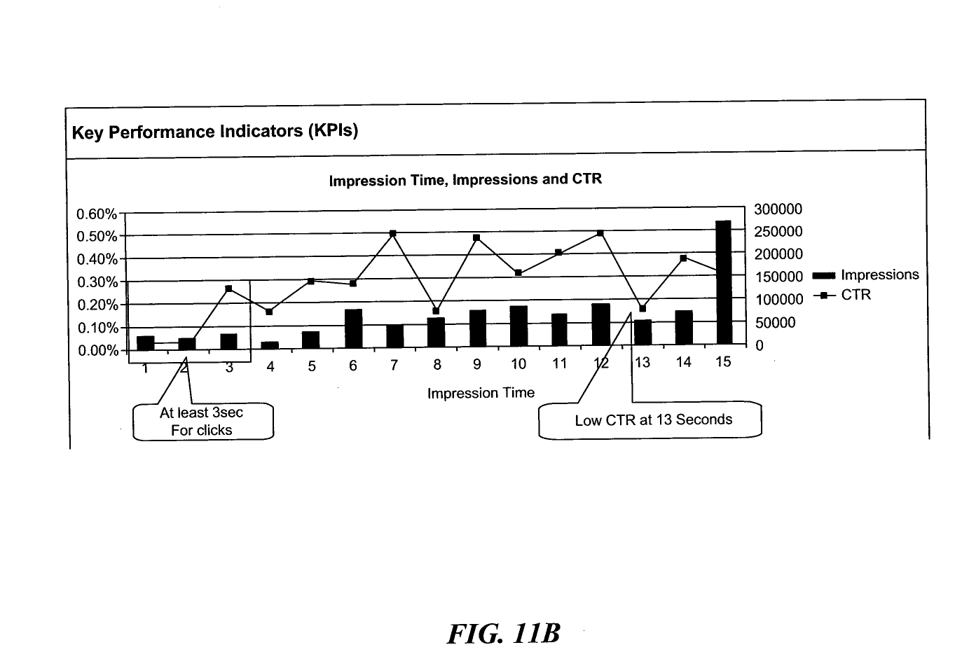

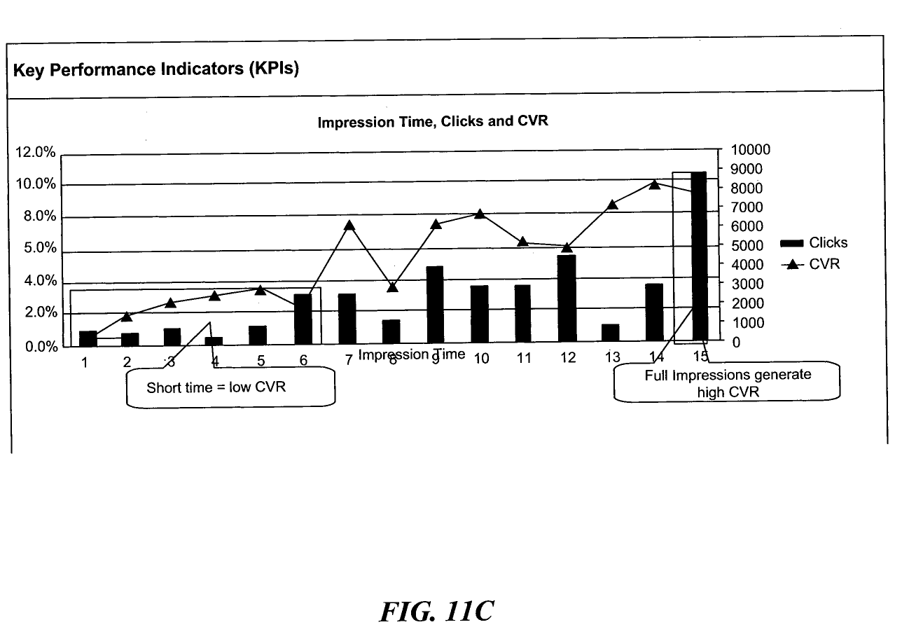

In addition to GRP, another aspect of the technology introduced herein is an ability to identify and appreciate the efficacy of an ad campaign using key performance indicators (KPI) which allow advertisers to better tailor their ads for their target audience. One such KPI provided in the CPS-based ad platform is the effective impression time associated with an ad's keyword 806 and filter parameters 808. As illustrated in FIG. 11A, in a conventional ad platform, advertisers are generally provided ad performance metrics such as total impressions, total number of clicks, CTR, conversions and conversion rates. In a CPS-based ad platform, advertisers are provided not only the above mentioned conventional performance metrics; but additional performance indicators such as impression time and the total effective impression time. For example, in FIG. 11A, when ads with keywords 806 such as “Baseball” are associated with an ad, the advertisers are given not only the conventional performance metrics like CTR, they are also provided the ad's impression time and the total effective impression time. The advertisers can then truly gauge viewer interest in the ad, for e.g., based on whether the keyword “Baseball” associated with the ad helped place the ad in an appropriate forum. Similarly, when ads with filter 808 such as “ESPN.com” are associated with an ad, the advertisers can then truly gauge viewer interest in the ad, for e.g., based on whether the website “ESPN.com” associated with the ad helped place the ad in an appropriate forum. Also, a combination of keyword 806 and filter 808 parameters that generate a high effective impression would be very helpful to the advertisers to better target their ad spending effectively.

Another KPI provided in the CPS-based ad platform is the correlation between impression time and CTR for an ad campaign. As illustrated in FIG. 11B and 11C, in a conventional ad platform, advertisers are generally provided ad performance metrics such as total impressions, total number of clicks, CTR, conversions and conversion rates. However, advertisers are generally clueless as to at what point in a given ad's play-time was the ad clicked by the user or what the minimum play-time needs to lapse before a user will click an ad. These metrics are highly relevant to an advertiser because they help advertisers determine if an ad's content appeals to its target audience. The metrics also help determine what the best length for an ad should be to generate high number of viewer clicks. In FIGS. 11B and 11C, it can seen that, when ads are played for less than 3 seconds, the percentage of clicks generated within that time period is dose to zero. This is understandable, given that users need to at least watch the ad for a few seconds before they will click. As the impression time increases and reaches the full ad length of 15 seconds, the percentage of clicks generated is the highest at this point. Again, this is understandable given that users who watched the entire ad were more likely to click the ad than those who didn't. Another interesting observation that advertisers can utilize in tailoring theirs ads is determine the point of low CTR compared to length of play-time. In FIG. 11B, at 13 seconds of play-time, the percentage of clicks is dose to that of at the 5 or 7 second play-time. This could be, for e.g., because viewers lost interest in the ad's content. Based on this information, advertisers can tailor their ad lengths and messages accordingly to try and reengage the audience they were losing at the end of the ad play-time.

### Tracking Ad Relevancy Using User Interaction

Another practical result of the technology introduced herein is the various provisions available within the ad platform that allows advertisers to track a user's interaction with displayed advertisements and improve the efficiency and relevance (from the user's perspective) of future advertisements shown that best matches the user's interest. In one embodiment, the tracking could be done using cookies that capture a user's interaction with a displayed ad. Many other ways exists for tracking a user's interaction with any specified portion of a publisher's webpage or other content, including advertisements displayed on portions of the publisher's webpage. Any such method works with the present invention.

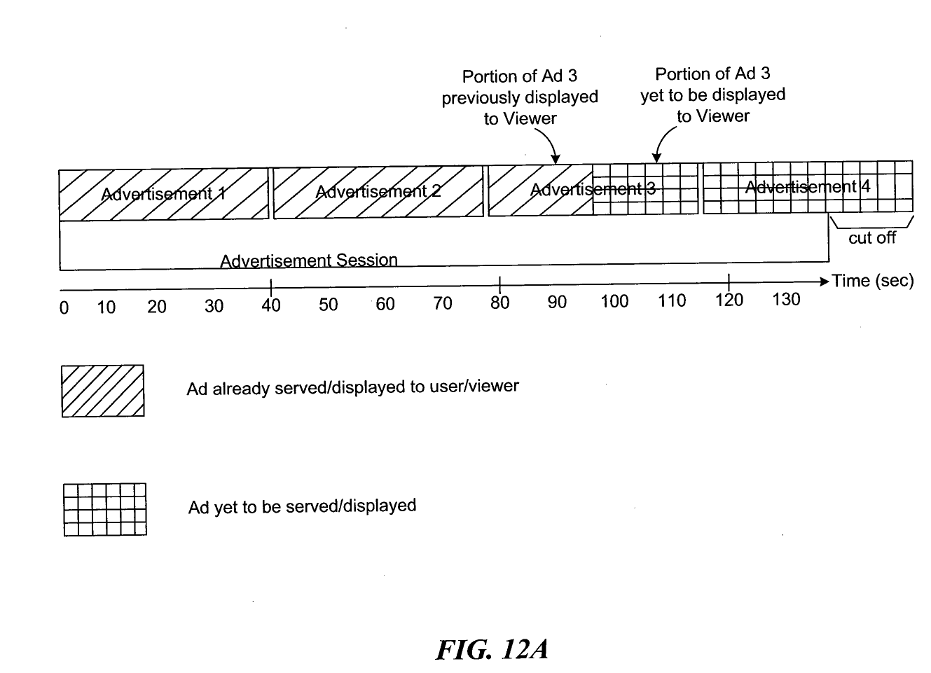

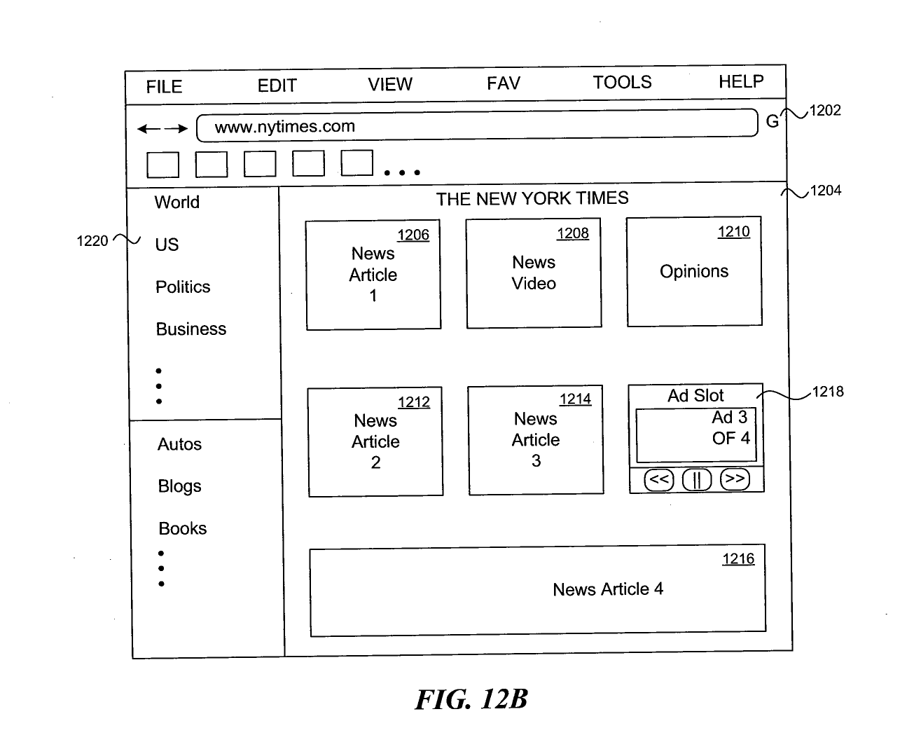

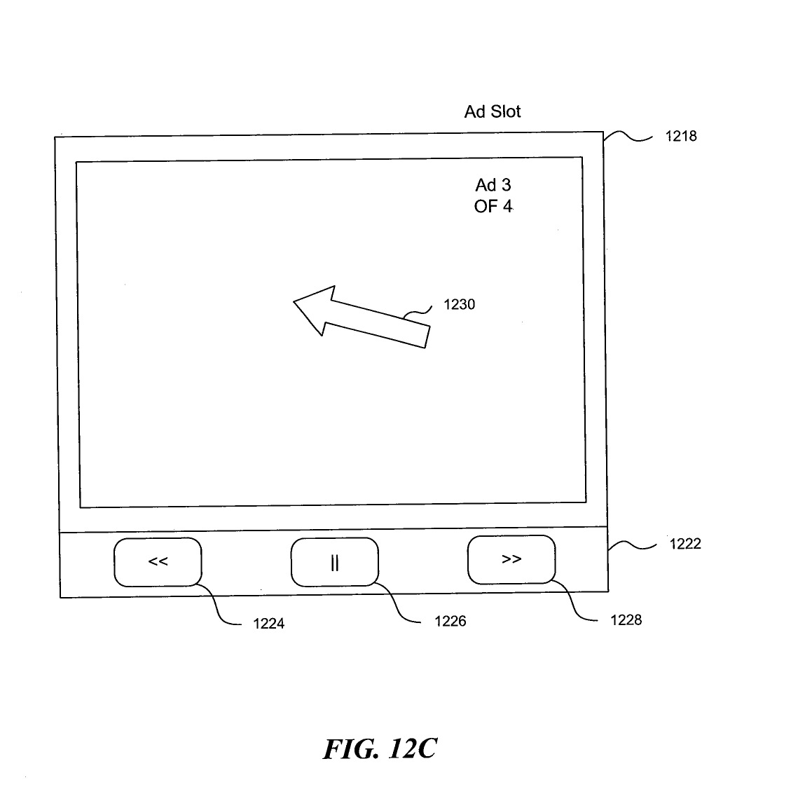

In the CPS methodology, as illustrated in FIG. 3C and FIG. 12A, the entire user session in a given publisher's website becomes a single unit ad slot, dissected into seconds. Sessions can be tailored to the exact needs of advertisers. Page views will no longer matter. When using advertisements of variable lengths such as those devised by the techniques described herein, the switching of advertisements are based not on page transition, but on time. A user transition from one page view to another does not cut-off an ad. Instead, the ad is resumed in the next page view until it is fully played.

For example, as illustrated in FIG. 3C, in a 110-second user session, 70 seconds can be allocated to advertiser A, another 30 seconds to advertiser B, and 5 seconds to advertiser C. When the user transitions from page view 1 to page view 2 after 45 seconds, 25 seconds of play-time is still left on ad A. Therefore, ad A is resumed and played for the remaining 25 seconds in page view 2 before ad B is played, Once ad A is complete, ad B is played for 30 seconds. When the user transitions to page view 3, ad B is fully played. So, ad C starts playing at the beginning of page view 3. However, the user ends the session with 20 seconds of play-time left in ad C. Therefore, the advertiser is charged only for the 5 seconds of the 25 second play-time ad C was played. Thus, page views will no longer matter, and the multiple advertisements A, B and C rotate one after the other in a predetermined order.

In one embodiment, the ad platform utilizes the advertisement rotation in a given user session and the order of displayed advertisements in the rotation to enable a user to return to previously displayed advertisements and forward back to any displayed point in the advertisement last served before the return. The ad platform tracks the users returns and forwards to identify both a positive impression of the user based on the attention drawn to the displayed advertisement and the relevancy of the displayed advertisement based on the advertisement that was replayed by the user. The ad platform could utilize information relating to the advertisement that was replayed by the user to identify other advertisements that are closely associated with the replayed advertisement and serve such identified advertisements to the user. In one instance, the associated advertisements that were identified could be added to the advertisement rotation that is being displayed to the user in the current user session. In another instance, the ad platform could score the relevance of the identified associated advertisements higher when determining advertisements to be placed in rotation in a later user session for the same user, increasing the chances of the advertisements that drew the users attention earlier is displayed.

For example, as illustrated in FIGS. 12A, 12B, and 12C, in a 140-second user session in a publishers website 1204, viewed through a web browser 1202, an ad slot 1218 is available in the to publisher's website 1204 to display 140 seconds of advertisement amongst other publisher news content 1206, 1208, 1210, 1212, 1214 and 1216. As shown in FIG. 12A, of the 140 seconds available for advertisement in ad slot 1218, 40 seconds can be allocated to advertisement 1 another 40 seconds to advertisement 2, another 40 seconds to advertisement 3 and 20 seconds to advertisement 4. Advertisements 1 and 2 have been completely served over 80 seconds. About 20 seconds of advertisement 3 has been displayed to the user with another 20 seconds of advertisement 3 and about 50 seconds of advertisement 4 still left to be displayed to the user in the current user session. The ad platform maintains the loaded advertisements, including the previously played advertisements, in the user's system even after the advertisement has been displayed to the user. In some instances, the ad platform could allow the user to navigate and play any advertisement, from any timeline point, which has already been loaded into the user's system.

In one embodiment, when a user wishes to replay either of the previously displayed advertisements 1 and 2 or restart advertisement 3 from the beginning, the user can use the navigation bar 1222 integrated within the ad slot 1218 to transition to any of the previously displayed advertisements. For example, when the user clicks the rewind button 1224 once in the middle of the display of advertisement 3, the ad slot 1218 will rewind the ad back to the beginning of advertisement 3 and replay. When the user clicks the rewind button 1224 twice in the middle of the display of advertisement 3, the ad slot 1218 will rewind the ad back to the beginning of advertisement 2 and replay. Similarly, if the user again clicks the rewind button 1224 once as the ad slot 1218 transitions to the beginning of advertisement 2, the ad slot 1218 will rewind the ad back to the beginning of advertisement 1 and replay advertisement 1. Other similar combinations of clicks to transitions are possible and this embodiment is not limited to the above described embodiment of a combination of clicks and transitions within a given ad slot. Any known similar combinations of clicks to transitions can be used along with the present invention.

Once the user has watched the replay of an advertisement, the user may wish to skip any intermediate advertisement between the replayed advertisement and the advertisement that is yet to be fully served at least once to the user and return to fully watch the advertisement that is yet to be fully served. For example, after the user has watched advertisement 1, the user can use the navigation bar 1222 to navigate to either advertisement 2 or 3. The user could click on the forward button 1228 once to transition to advertisement 2 at any point during the viewing of advertisement 1. Similar to the rewind button 1224, clicking the forward button 1228 twice will transition the user to advertisement 3 at any point during the viewing of advertisement 1.

In one embodiment, any additional click counts on the forward button 1228 over two, when watching advertisement 1, will not transition the user to advertisement 4 or above. The user will have to fully watch advertisement 3 before the user could skip to advertisement 4. In another embodiment, clicking the forward button 1228 will let a user transition up to the last advertisement that has been at least partially loaded into the user's system, irrespective of whether any intermediate advertisements between the replayed advertisement and the last loaded advertisement is yet to be fully watched by the user. Other similar combinations of clicks to transitions are possible and this embodiment is not limited to the above described embodiment of a combination of clicks and transitions within a given ad slot. Any known similar combinations of clicks to transitions can be used along with the present invention.

In another embodiment, the user can perform the above described transitions between advertisements based on other well known methods that allow a user to transition between different segments of rich media displayed to a user through a compatible widget embedded in a given web page or a given web browser. For example, in one embodiment, a user can use a mouse pointer 1230 within the ad slot and a motion of the mouse pointer 1230, within the ad slot, left or right along with a click, can rewind or forward the advertisement. A motion left could be signal a rewind while a motion right could signal a forward. The granularity of the rewind or forward of the advertisements per motion-click could be a single advertisement, a few seconds of an advertisement, etc. Other similar forms of clicks to signal a transition are possible and this embodiment is not limited to the above described embodiment. Any known similar combinations of mouse motions with clicks could be used to signal transitions and can be used along with the present invention.

In one instance, the ad platform could utilize the number of user rewind or forwards clicks to determine the exact advertisement the user is interested in watching again. The ad platform could analyze the identified advertisement the user replayed to improve relevancy of later served advertisements to the user. For example, if a user replayed advertisement 1, which is related to a Honda automobile, the ad platform could start serving the user with advertisements related to new automobiles, automobile financing, automobile warranties, etc., which are highly likely to appeal to the user if the user is interested in buying a new automobile.

Similarly, in another instance, the ad platform could utilize the tracking to increase the cost of advertisement display to one advertiser and reduce the cost to the other based on the actual viewing of the advertisement by the user. For example, when a user skipped part way through advertisement 3 and returned to advertisement 1 to watch it again, the ad platform could charge the advertiser of advertisement 1 for serving the advertisement twice to the user. Similarly, the advertiser of advertisement 3 will be charged only for the portion of the advertisement, based on the actual viewed length, by the user instead of charging the advertiser of advertisement 3 for the display of the whole ad. In one instance, given that the user is going out of her way to replay a previously displayed ad, there is increased likelihood that the user is actually viewing the replayed advertisement 1. In such a scenario, the ad platform could charge the advertiser of the replayed advertisement 1 a higher eCPS charge for any portion of the replayed advertisement than the eCPS charge for displaying the advertisement the first time to the user.

Upon reading this disclosure, those of skill in the art will appreciate still additional alternative structural and functional designs for a system and a process for tracking ad relevancy using user interaction through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

### Examples of Practical Applicability of the CPS-Based Advertising Paradigm

A practical result of the technology introduced herein is an increase in efficiency and relevance (from the user's side) that an advertisement shown is relevant and matches the user's interest. On the publisher/media's side, the loss or waste in advertisement space is substantially mitigated. On the advertisers' side, by displaying advertisements only for a necessary and sufficient length of time and by being charged accordingly, the cost for a certain branding effort can be measured with higher accuracy and can also be implemented more efficiently. Additionally, in embodiments, the implementation of a unique bidding and sales technique that combines branding advertisement and direct response advertisements, results in at least the following perceivable advantages: (1) the set of options for advertisement sales will increase; (2) sales schemes and strategies will diversify and become increasingly specific; and (3) as a result, an expansion of the entire market can be expected.

In online advertisement, due to the legacy that search advertisement was the first major success, direct response advertisements, usually traded using Cost per Click (CPC) and Cost per Action (CPA), have been the mainstream. However, in the internet market as of today, the internet has become a “media” with the introduction of social media, etc., along with conventional search engines (CPC advertisement) and e-commerce engines (CPA advertisement), and the average page view length or session length is becoming significantly longer. Cost per Mille (CPM) is used often in conventional internet advertisement as the billing method for branding advertisements, and the recommended/suggested bidding price is often calculated using eCPM (CPC×CTR×1000), but if advertisements are supposed to be sold for branding purposes, there would be no logical foundation in using eCPM. One of the reasons for the lack of such a logical foundation is that with eCPM, the CTR (which is an index that is relevant for direct response advertisements) is the decisive factor in determining the price. CPS, on the other hand, offers methods and systems of selling the length of time that an advertisement is displayed on the user's screen, which is independent of CTR and other direct response advertisement-related indices, making CPS a much fairer and efficient scheme of selling advertisements. CPS causes internet or e-commerce advertising measurable and accountable in a manner similar to how audience ratings and CPM cater to television broadcasting.

In the exemplary illustrations outlined above, a method and system was identified for comparing “eCPS” in relation to “eCPM.” The technology disclosed herein allows for indices such as the total viewing time on the publisher side, number of views of an ad (AV), average number of seconds that an ad has been seen (AAVL), etc., to be measured and calculated. Such measurement is not possible in conventional online advertisements. These indices further offer a mechanism to calculate the suggested value of eCPM and compare with the suggested value against other advertising schemes (i.e., when eCPM is replaced with, for example, CPS (for branding) or CPS×CPC (for branding and direct response)).

“eCPS” expresses the suggested price for bCPS (branding CPS) alone as well as “bdCPS×bdCPC” (branding and direct response). Therefore, as discussed in the various scenarios above, the conventional value of (eCPM) is comparable with the various values or schemes identified herein (eCPS bCPS bdCPS×bdCPC). eCPS, is an index that has its primary focus on branding, as compared to conventional eCPM which primarily focuses on direct response. eCPM is also affected by other indices such as CTR and CPC that are directly associated with direct response advertisements, and eCPS allows for such influences to be ignored.

A key feature of the technology introduced herein is that “high quality media with higher levels of user engagement”, which had been seriously undervalued due to the conventional eCPM valuation, will be able to sell their advertisement space based on the actual time that advertisements have been displayed on users' screens. Additionally, the technology enables value to be revived and allows these “high quality media” to receive advertisement fees commensurate with their “high quality” contents. On media that have “high quality” content, the users stay at pages longer, have longer sessions, and will not readily depart or jump away from pages. As a result, CTR is lower, and when calculations of advertisement value are conducted using eCPM, the price for advertisement on this media turns out to be lower than “low quality” media such as a website that is packed with links (thus having higher CTR). However, as disclosed herein with reference to the CPS-based technology, such discrepancy is resolved by valuing high quality media for the high quality of their contents. The technology thus allows higher quality contents and advertisements to be published, imparting benefits to the entire advertising ecosystem—the publisher, the advertiser, and the user.

### Illustration of Ecosystem Utilizing an Integrated Ad Platform for Ad-Slot Inventory Purchase, Ad-Slot Bid Price Adjustment, and Ad-Slot Bid Score Calculation

As illustrated below with reference to FIGS. 10B and 10C, the methods and systems disclosed herein disclose another embodiment of an integrated ad platform that allows advertisers to buy inventory of ad slots in media, adjust ad-slot bid price, calculate ad-slot bid score, and calculate GRP related metrics.

### Media Inventor, and Cookie

In one embodiment, media, inventory (ad frame) and cookies are defined as in the below example, where a user with certain attribute information cookieₕ accesses a media Mᵢ, and the ad platform provides the advertisers with an opportunity to show an ad to this user through an ad inventory (ad frame) F_{i,j} associated with the ad platform.

In some embodiment, there are two general logics as to how advertising opportunities are bought. The first is to bid for the inventory (ad frame) itself (e.g. buying inventor in bulk such as by CPM). The other is to bid based on the attribute information that the user has (e.g. bidding for a single impression to a specific cookie, as in real-time bidding, or RTB). With the disclosed ad platform, both of these logics could be combined into a single bidding logic. The details are discussed in later sections, but here, an example based on CPM, which is more of an inventory-buying approach is used to illustrate the ad platform. Also, for a RTB based method, one needs to apply the same logic but replace the term “inventory” or “ad frame” in CPM based bid to the term “cookie” as associated with RTB.

For an inventory (ad frame) F_{i,j}, AVT_{i,j} defines the average viewable time (AVT) that the inventory (ad frame) F_{i,j} has been 60% or more visible on the screen in terms of area, per page view, during a specified time period T.

### Advertisers and Campaigns

In one embodiment, advertisers and campaigns are defined as below.

In some embodiments, AL_{k,l} is defined as the length of the ad creative that is specified for an advertising campaign Camp_{k,l} of advertiser Advₖ (if the ad creative is a still banner, then the advertiser specifies the length through the dashboard). The number of times that the ad creative has been shown in campaign Camp_{k,l} is defined as Imp_{k,l}, and the Weighted Average Ad Length (wAAL) refers to the weighted average of all ads that have been served to a certain ad frame F_{i,j} during time period T. wAAL is defined as:

$${wAAL}_{i , j , k , l} = \frac{{\sum }_{k , l} ( {AL}_{i , j , k , l} \times {Imp}_{i , j , k , l} )}{{\sum }_{i , j , k , l} ( {Imp}_{i , j , k , l} )} . \qquad ( 22 )$$

Here, Imp_{i,j,k,l} is the number of times that Ad l by advertiser k has been served to inventory j of Media i, and AL_{i,j,k,l} is the length of this ad.

If Effective Impression (eImp) is defined as the full serving of an ad of length AL_{k,l}, the number of Effective impressions that can be shown within a page view can be expressed as

$${eImp}_{k , l} = \frac{{AIT}_{i , j}}{{AL}_{k , l}} . \qquad ( 23 )$$

### Cost-Per-Second and the Suggested Bid Value

In one embodiment, p_{i,j} is defined as the average price during period T for buying a single impression of inventory F_{i,j} (the traditional concept of property-based inventory can be replaced by a cookie-based approach such as in RTB). The number of seconds of ad impression of F_{i,j} that can be bought with p_{i,j}, is AVT_{i,j}. If the unit of sales differs, the logic is adjusted accordingly (e.g. if the unit of sales is per Mille Effective Impressions, we may use 1,000×p_{i,j} as a reference value).

The average number of seconds for which all advertisers in period T had an advertising strategy (e.g. the length of the video uploaded, the length of banner impression specified) for inventory F_{i,j} is wAAL. Therefore, the cost-per-second of strategic time (time for which advertisers had an advertising strategy) can be defined as:

$${cps}_{i , j} = \frac{{p}_{i , j}}{{wAAL}_{i , j , k , l}} . \qquad ( 24 )$$

Conventionally, advertiser Advₖ paid p_{i,j} buy inventory F_{i,j} and showed AL_{k,l} seconds of their ad, but the advertiser only had a strategy for the AL_{k,l} seconds, so the remaining (AIT_{i,j}−AL_{k,l}) seconds were wasted.

The integrated ad platform, in one embodiment, is able to bring more than one advertiser per page view, and thus AL_{k,l} seconds of inventory F_{i,j} can be sold to advertiser Advₖ. The cost per second used to calculate the suggested bid value for this advertiser is cps_{i,j}, and therefore the suggested bid value for advertiser Advₖ is bid_{suggested}=cps_{i,j}×AL_{k,l}.

With the integrated ad platform, a total of

$${\hat{p}}_{i , j} = \frac{{AIT}_{i , j}}{{wAAL}_{k , l}} \times {p}_{i , j}$$

can be sold per page view, and therefore \hat{p}_{i,j}−p_{i,j} becomes the extra margin generated by the integrated ad platform logic.

### Adjustment of Bid Value

The trade (buying and selling) of inventory is generally based on an auction, and therefore if the bid value is not high enough, the inventory cannot be bought at a pace commanded by the campaign, and if the bid value is excessively high, unnecessary costs are being paid. Therefore, the bid value should be adjusted according to the actual performance.

Assuming that the general market price for buying a certain inventory is p_{i,j}, we use p_{i,j} as the base value.

If the duration of campaign Camp_{k,l} is t_{Camp}_{_{k,l}} and the time period necessary to determine whether an adjustment in the bid value is necessary or no is tₜₑₛₜ, the number of judgments that would be conducted during this campaign Camp_{k,l} would be

$$\vert {test}_{{Camp}_{k , i}} \vert = \frac{{t}_{{Camp}_{k , l}}}{{t}_{test}} .$$

We also express the mth test (judgment) of the campaign as testₘ. If tₜₑₛₜ=1, a judgment will be made after each impression served.

We now define buy_{i,j,test}_{ₘ} as the number of bids that are placed by integrated ad platform for inventory F_{i,j} during testₘ, and win_{i,j,test}_{ₘ} as the number of wins during this period. From this, we can define the rate of winning as

$${winrate}_{i , j , {test}_{m}} = \frac{{win}_{i , j , {test}_{m}}}{{buy}_{i , j , {test}_{m}}} . \qquad ( 25 )$$

If winrate_{i,j,test}_{ₘ} falls below a certain optimal value winrate_{i,j,optimal} defined for various reasons (e.g. to reach campaign goals), the size of the inventory would not suffice in meeting the campaign goals of advertisers. Campaign goals can be defined by various indices, such as Reach, Action, Budget & Cost, etc. Reach could be further defined by factors such as (a) total impressions; (b) total unique browsers; (c) effective impressions; (d) unique browsers to which effective impressions are served; (e) total seconds; (f) GRP; etc. Action could be further defined by factors such as (a) clicks; (b) conversions; (c) organic searches; (d) social actions such as Facebook likes, Facebook shares, Tweets, Google+, Dennoo Save, etc. Budget & Cost could be further defined by factors such as (a) budget used; (b) cost per action; (c) cost per second; etc.

The example shown below is based on the total impressions served. For a given advertiser Advₖ and campaign Camp_{k,l}, if the total number of impressions served is TotalImpressions_{Camp}_{_{k,l}}, and the goal is to reach GoalImpressions_{Camp}_{_{i,j}}, a “successful campaign” for this advertiser would simply be TotalImpressions_{Camp}_{_{k,l}}≧GoalImpressions_{Camp}_{_{k,l}}.

If ones assumes that Advₖ is the only advertiser and campaign Camp_{k,l} is the only campaign, and therefore all inventory bought by the integrated ad platform during testₘ is used by Camp_{k,l}, the number of impressions served at the time that testₘ would amount to win_{i,j,test}_{ₘ}.

At this time, if

$$\frac{{t}_{test}}{{t}_{{Camp}_{k , i}}} >> \frac{{win}_{i , j , {test}_{m}}}{{GoalImpressions}_{{Camp}_{k , i}}} ,$$

then it can be predicted that the campaign goals would not be met. On the other hand, if

$$\frac{{t}_{test}}{{t}_{{Camp}_{k , i}}} << \frac{{win}_{i , j , {test}_{m}}}{{GoalImpressions}_{{Camp}_{k , i}}} ,$$

the campaign goals may be met, but the pace may be too fast, and the campaign budget may be used up before the campaign period is over.

Therefore, in order to meet the campaign goals under an appropriate schedule, the integrated ad platform must purchase the inventory at the optimal price, which shall be defined as below:

If the bid price by the integrated ad platform for inventory F_{i,j} during testₘ is dennoobid_{i,j,m}, then the bid price at m=1 would be dennoobid_{i,j,1}=p_{i,j}.

At this time, if winrate_{i,j,test}_{₁} falls below the optimal rate winrate_{i,j,test}_{₁} (determined based on, for example, campaign goals), then at m=2, the bid would be placed at bid_{i,j,2}=p_{i,j}+a, and if winrate_{i,j,test}_{₁} is above the optimal rate winrate_{i,j,optimal}, a bid will be placed at bid_{i,j,2}=p_{i,j}−a.

Next, at m=2, if winrate_{i,j,test}_{₂}<winrate_{i,j,optimal} again falls below the optimal rate winrate_{i,j,optimal} determined by the integrated ad platform, at m=2, a bid will be placed at bid_{i,j,2}=p_{i,j}+2a. On the other hand, if winrate_{i,j,test}_{₂}>winrate_{i,j,optimal} again, a bid will be placed at bid_{i,j,2}=p_{i,j}−2a. If winrate_{i,j,test}_{₂}<winrate_{i,j,optimal} at m=1 and winrate_{i,j,test}_{₂}>winrate_{i,j,optimal} at m=2, then a bid will be placed again at bid_{i,j,2}=p_{i,j}+a.

If the campaign begins at m=1, the number of wins at m can be expressed as below.

$${\sum }_{1}^{m} {win}_{i , j , {test}_{m}} \qquad ( 26 )$$

Similarly, the number of losses can be defined as below.

$${\sum }_{1}^{m} ( {bid}_{i , j , {test}_{m}} - {win}_{i , j , {test}_{m}} ) \qquad ( 27 )$$

Therefore, the bid value at m can be expressed as below.

$${bid}_{i , j , m} = {p}_{i , j} + {\sum }_{1}^{m} ( 2 {win}_{i , j , {test}_{m}} - {bid}_{i , j , {test}_{m}} ) \qquad ( 28 )$$

The advertiser can designate a maximum bid value maxbid_{k,l,m}, and depending on this value, even if winrate_{i,j,optimal} is not reached, the adjustment of dennoobid_{i,j,m} may stop. For example, if there is only one advertiser bidding on the integrated ad platform, winning a bid at a value larger than maxbid_{k,l,m} would generate a loss for the integrated ad platform, so the bid value will not be increased.

### Bid Score and the Selection of Advertisers

In one embodiment, the judgment as to which advertiser's ad should be served in an ad-slot through the integrated ad platform will be determined by the campaign and targeting settings designated by the advertisers. There are two main ways by which targeting can be set for a campaign.

Under the first method, advertisements are not shown in an ad-slot if the various ad and ad-slot attributes do not match. Some of the attributes used in the determination are (a) media targeting, i.e., designating a specific media Mᵢ; (b) geographic targeting; (c) demographic targeting; (d) day and time parting (specific dates, days, times), etc. Under the second method, advertisements are shown based on a bid score, where the bid score is calculated using attributes such as (a) ad-slot bid value; (b) interest matching (e.g. keywords, categories); (c) continuation of Ad between page views, etc.

Based on the above, an example of the calculation of bid score may be expressed as the below:

$${Bidscore}_{i , j , k , l} = ( {target}_{media} \times … \times {target}_{geo} ) ( {\sum }_{n}^{ } {a}_{n} {x}_{n} ) \qquad ( 29 )$$

Here, the variables target_{media}× . . . ×target_{geo} take a value of 1 if it matches the designation by the campaign, and takes a value of 0 if it does not match the designation of the campaign. n is a set of campaign score variables, xₙ is its value, and is the coefficient that designates the weight of this campaign score.

Three examples of score variables are (a) Bidding Score a_{bid}x_{bid}=a_{bid}×bid_{i,j,m}; (b) Interest Matching Score aᵢₙₜₑᵣₑₛₜxᵢₙₜₑᵣₑₛₜ; and (c) Continuation Score a_{continue}x_{continue}.

With the integrated ad platform, if the user jumps to a different page within the session, and there is a compatible ad frame, at the next page, the remainder of the ad will be served at that page. The continuation score will take a value when the user's cookie holds information about a previous ad serve (that meets certain criteria such as the time gap between the previous impression and the current) and how long it was served during the previous impression.

Five examples of the targeting scores are (a) Media targeting target_{media}; (b) Geographic targeting target_{geo}; (c) Demographic targeting target_{demo}; (d) Day Parting targetₜᵢₘₑ; and (e) Frequency Control target_{freq}. An example of the definition of a bid score is expressed as:

2win_{i,j,test}_{ₘ}−bid_{i,j,test}_{ₘ})

Further, in another embodiment, a “recency value” can be used in the calculation of the bid score. In one embodiment, “recency” is basically the idea that before a conversion (e.g. brochure request through an advertiser's website, where such as request was the intended final goal of an ad campaign), the user is exposed to ads multiple times. For example, the user could have been exposed to a banner ad at Facebook, a second video ad at Yahoo!, and then finally searched for a related keyword, and clicked on an ad to arrive at the landing page, resulting in a “conversion”.

In one embodiment, by tracking the various impressions and the relative time period of conversion, the integrated ad platform can identify the “recency” of a particular impression (for example, it is the third impression to this user) and the associated conversion with that “recency”. Accordingly, the bid score corresponding to a particular “recency” can be adjusted to reflect this added value to the advertiser. Further, if the ad platform determines that the user has not been exposed to any impressions before the search and conversion, then the ad platform can attribute it to offline ads that the user has been exposed to.

In one embodiment, in the integrated ad platform, the order of the ads served will be determined based on the bid score of each ad, with the higher score leading to a higher preference for showing in the given ad-slot.

Maximizing Amount of User Viewing Time while Reducing Overall Ad Cost

In one embodiment, the amount of viewing time can be increased while the overall ad cost can be reduced by buying impressions with long viewable time and low CPM. Here, in embodiments, impressions are bought from Real-Time Bidding (RTB), where bids are made on CPM basis. Before bidding, the ad platform gathers sufficient amount of information to estimate the following values for known ad inventories A={a₁, . . . aₙ}: (1) average viewable time Tᵢ of aᵢ; (2) eCPI mᵢ of aᵢ; (3) the expected number of aᵢ's impressions nᵢ.

In embodiments, aᵢ is ordered such that

$$\frac{{m}_{i}}{{T}_{i}} \leq \frac{{m}_{j}}{{T}_{j}}$$

if i<j. Further,

$$\frac{{m}_{i}}{{T}_{i}}$$

refers to the ePPS (estimated price per second), where if ePPS is low, then the amount of advertisement cost tends to be low. Therefore, ePPS of aᵢ is not greater than that of aⱼ if i<j. Further, in embodiments, all aᵢ's have the same combination of targeting attributes. Several examples of targeting attributes are: (1) information on the user (location, referrer, etc.); (2) type of a website to which the ad slot belongs to (sports, finance, etc.); (3) time of day.

For the above embodiment, the ad platform targets to achieve the goal g_{c} of each campaign cεC_{A}, where C_{A} is the set of all campaigns which are suitable for all of the ad inventories in A. Here g_{c} is given in the unit of second. Further, even if the goal is given in the form of the number of impressions n_{c}, the ad platform can set g_{c}=n_{c}×l_{c}, where l_{c} is the ad length of this campaign's ad. In addition, two sets of campaigns C_{A1} and C_{A2} are disjoint if A₁ and A₂ have different targeting attributes.

Method:

The following part describes how the ad platform can achieve g_{c} for each cεC_{A} with less spending. In one embodiment, the ad platform first describe how we can sift out ad inventories with high ePPS, then expresses how the ad platform can make bids to win, and finally make adjustment to the criteria of sifting

Sifting Out Costly Ad Inventories:

To achieve all campaigns' goals, the ad platform need to acquire G=Σ_{cεC}_{_{A}}g_{c} seconds through auctions at the RTB. Now let the ad platform take the smallest θ so that Σ_{i≦θ}nᵢ·Tᵢ≧G. Then in order to obtain this amount of viewable time, it is sufficient to win all impressions ePPS of which is less than or equal to

$$\frac{{m}_{θ}}{{T}_{θ}} .$$

Moreover, if this condition is satisfied, each campaign has obtained more impressions than desired. Thus, all impressions the ad platform need to buy are, theoretically, impressions generated from aᵢ's, where i≦θ.

Bid Making:

In order to win these impressions, the ad platform needs to make high bids when necessary. Here, for instance, the ad platform has score α≧0, that takes higher (or lower) value if the campaigns are underachieving (or overachieving). Then, ad platform can make the following bid b when an impression is offered from ad inventory aᵢ(i≦θ):

b=λmᵢ+(1+λ)α (30)

where 0≦λ≦1 is some constant. b>mᵢ if mᵢ>α and b<mᵢ if α<mᵢ.

The previous bid is made based on eCPM price, but ad platform can make a similar bid based on ePPS price:

$$b = {T}_{i} \cdot ( λ \frac{{m}_{i}}{{T}_{i}} + ( 1 - λ ) α ) \qquad ( 31 )$$

Here ad platform assumed “a” is transformed appropriately to be used in this equation.

Adjustment to Criteria:

In the previous argument, the ad platform bid only for ad inventories aᵢ with indices i≦θ. Since the ad platform took smallest θ, there is no room for loss at the RTB. The following two methods can allow the ad platform to lose in auctions: (1) The ad platform takes the smallest θ so that Σ_{i≦θ}nᵢ·Tᵢ≧α₀·G for some α₀>1; (2) The ad platform leaves θ unchanged, but allows to bid for impressions derived from ad inventories which have higher ePPS than ad inventory a_{θ} does.

If the ad platform takes option 1, then the ad platform has more chances to bid for impressions while allowing for loss. If the ad platform takes option 2, the ad platform could make a lower eCPM bid for ad inventories with higher ePPS. The ad platform can do this by the following procedure: (1) Let \hat{m}ᵢ=ƒ(mᵢ), where f is some function which assigns \hat{m}ᵢ≅mᵢ if i≦θ and \hat{m}ᵢ<mᵢ if i>θ;

(2) The ad platform uses \hat{m}ᵢ in making bids, where could be equation 32 or 33:

$$\begin{matrix}b = λ {\hat{m}}_{i} + ( 1 - λ ) α & ( 32 ) \\ b = {T}_{i} \cdot ( λ \frac{{\hat{m}}_{i}}{{T}_{i}} + ( 1 - λ ) α ) & ( 33 )\end{matrix}$$

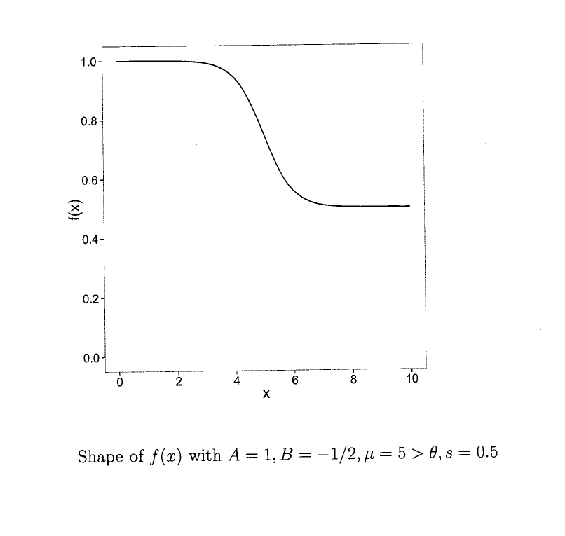

An example of function f is:

$$f ( x ) = A + \frac{B}{1 + exp ( - ( \frac{χ - μ}{s} ) )} \qquad ( 34 )$$

where A, B, μ, s are constant. As illustrated in FIG. 16, if we set A=1, B=−1/2, μ=5>θ, s=0.5, then f(x) has the shape shown in FIG. 16.

### Bidding and Displaying Advertisements in Smart Phones Utilizing Various Cost Models

In present ad platforms, the business model is that the ad inventory is provided by the media, and a margin (e.g. 50%) is taken based on results, and if results do not look like they should look, the inventory will no longer be provided. The ad inventory could be procured either in advance or through real-time bidding (RTB) by the ad platform.

Cost Model for Monetizing Smart Phones:

Media, providing inventory, could monetize smart phone venue through two cost models: (1) Ad space (fixed at the bottom of the screen), which will be sold by CPC; (2) Rich-media type ads that expand, which will be sold by CPS. The pricing logic will be Z×N÷Ad Length (AL)=CPS, where N is a coefficient necessary for covering the ad delivery costs. When deciding N, (Ad View Length):(Ad Length) is important. For example, if AVL:AL=1:3, then because the average viewing time of an ad is for instance, 5 sec out of 15 sec, 3 could be appropriate for N.

Combining models (1) and (2), the Total Ad cost=CPC+(Z×N÷AL)×AVL, where Z is the ad delivery cost. Here, with (1), the ad platform will optimize CTR by adjusting the rotation time. With (2), the CPS charging will be the “ad delivery cost” of delivering rich media ads. Therefore, it will be based on the ad delivery cost Z.

Advertisers will be charged standard CPC as the model for charging for the advertisement while CPS will be used as the “ad delivery cost” for the advertisement.

### Gross Rating Point (GRP)

Gross Rating Point (GRP) is generally defined as the measurement of delivering one impression of a given ad to 1% of the Potential Reach. Here, in one embodiment, Potential Reach refers to the number of unique browsers that match the targeting conditions designated for campaign Camp_{k,l}. The number of GRPs for a given campaign Camp_{k,l} can be expressed as below:

$${GRP}_{{Camp}_{k , i}} = \frac{{Reach}_{k , i}}{{PotReach}_{k , l}} \times {Freq}_{k , l} \times 100 \qquad ( 35 )$$

Additionally, Reach_{k,l} refers to the number of unique browsers to which ads are/were actually served to in Camp_{k,l}, and frequency Freq_{k,l} refers to the number of times that the same ad has been served to the same unique browser during a given time period.

Here, a television commercial is used to illustrate the online GRP as described above. For example, in Tokyo, where there are approximately 5 million households (i.e. Potential Reach), if a TV show reaches 1 million of these households (i.e. Reach), then the rating point would be 20%. If an ad is shown 3 times during this show, then the number of GRPs would be calculated as below,

$$\frac{1 , 000 , 000}{5 , 000 , 000} \times 3 \times 100 = 60 GRP \qquad ( 36 )$$

In another embodiment, PotReach_{k,l} is determined based on the campaign settings, and the maximum number of impressions per unique browser (or in the case of TV commercials, the number of TVs or households) is given by the frequency cap freqcap_{k,l} designated by the advertiser. If the PotReach_{k,l}, freqcap_{k,l} and the length of the ad to be served AL_{k,l} are determined, then the price per 1 GRP of GRP_{Camp}_{_{k,l}} can be defined by as below:

$${CPGRP}_{{Camp}_{k , l}} = \frac{{cps}_{i , j} \times {AL}_{k , l} \times {PotReach}_{k , l} \times {freqcap}_{k , l}}{100} \qquad ( 37 )$$

### Architecture of Platform Server

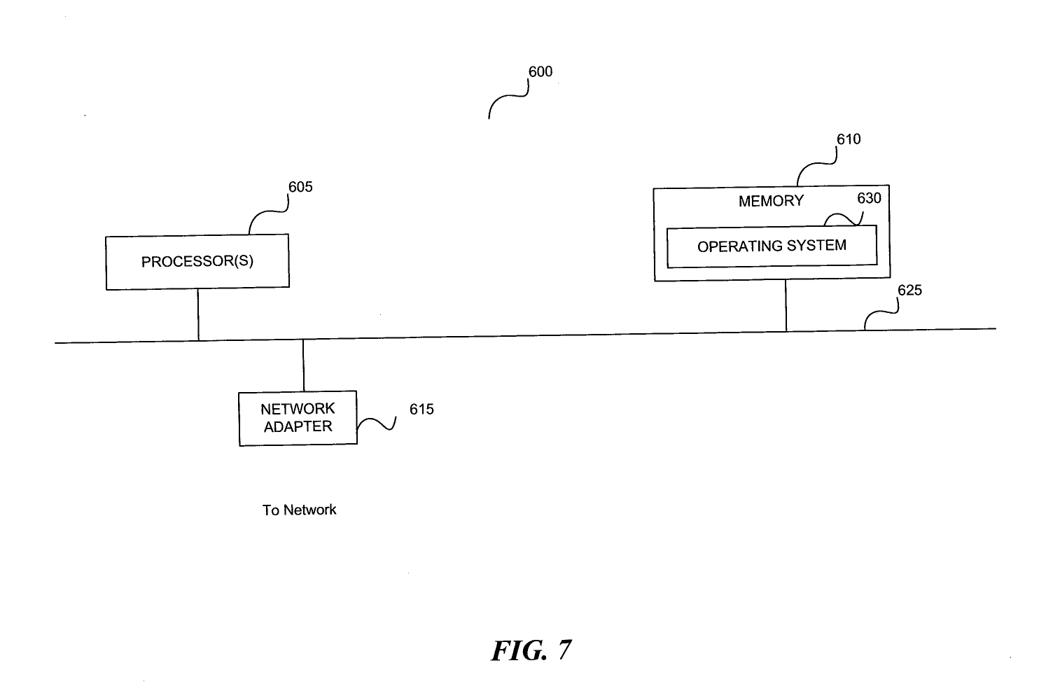

FIG. 7 is a high-level block diagram showing an example of the architecture for a computer system 600 that can be utilized to implement, for example, a platform server (e.g., 114 from FIG. 1), a web server (e.g., 125 from FIG. 1), or any other computing device identified in the above disclosure. In FIG. 6, the computer system 600 includes one or more processors 605 and memory 610 connected via an interconnect 625. The interconnect 625 is an abstraction that represents any one or more separate physical buses, point to point connections, or both connected by appropriate bridges, adapters, or controllers. The interconnect 625, therefore, may include, for example, a system bus, a Peripheral Component Interconnect (PCI) bus, a HyperTransport or industry standard architecture (USA) bus, a small computer system interface (SCSI) bus, a universal serial bus (USB), IIC (I2C) bus, or an Institute of Electrical and Electronics Engineers (IEEE) standard 694 bus, sometimes referred to as “Firewire.”

The processor(s) 605 may include central processing units (CPUs) to control the overall operation of, for example, the host computer. In certain embodiments, the processor(s) 605 accomplish this by executing software or firmware stored in memory 610. The processor(s) 605 may be, or may include, one or more programmable general-purpose or special-purpose microprocessors, digital signal processors, programmable controllers, application specific integrated circuits (ASICs), programmable logic devices (PLDs), or the like, or a combination of such devices.

The memory 610 is or includes the main memory of the computer system 1100. The memory 610 represents any form of random access memory (RAM), read-only memory (ROM), flash memory (as discussed above), or the like, or a combination of such devices. In use, the memory 610 may contain, among other things, a set of machine instructions which, when executed by processor 605, causes the processor 605 to perform operations to implement embodiments of the present invention.

Also connected to the processor(s) 605 through the interconnect 625 is a network adapter 615. The network adapter 615 provides the computer system 600 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

1. A method for processing and displaying an advertisement, the method comprising:
receiving, from an advertiser, by a platform server having a processor, the advertisement to be displayed in an advertising section of a publisher's webpage, the advertisement intended for display for a predefined duration of time within the advertising section;
transmitting, by the platform server, the advertisement for display within the advertising section of the publisher's webpage;
partitioning, by the platform server, the advertisement into a plurality of portions, the portions being of equal duration;
determining, by the platform server and for each of the portions, a cost for displaying a specific portion of the advertisement, the cost computed as a function of one or more user interactions with the specific portion of the advertisement; and
computing, by the platform server, a total cost for displaying the advertisement, the total cost computed as a function of determined cost of displayed portions.

2. The method of claim 1, wherein a given cost incurred for displaying a given portion of the advertisement is further computed as a function of a cost-per-second (CPS) model of displaying the advertisement within the advertising section, the cost-per-second model indicative of total duration of display of the given portion of the advertisement within the advertising section.

3. The method of claim 2, wherein when the given cost incurred for displaying the given portion of the advertisement is computed as a function of both the cost-per-second (CPS) model and a given user interaction of the one or more user interactions with the given portion of the advertisement, the given cost is computed as an effective CPS (eCPS) value, the eCPS value being a function of a predetermined value associated with the given user interaction.

4. The method of claim 3, wherein the given user interaction includes one or more of:
a mouse roll-over over the advertisement;
a user click of the advertisement;
a rewinding of the advertisement;
a pausing of the advertisement;
a playing of the advertisement; or
a entering of information into one or more forms associated with the advertisement.

5. The method of claim 3, wherein the predetermined value associated with the given user interaction is computed as a function of both a preference score associated with the given user interaction and a probability of occurrence of the given user interaction when displaying the given portion of the advertisement.

6. The method of claim 5, wherein the preference score associated with the given user interaction is computed as a function of a desirability of the given user interaction to a given advertiser when displaying the given portion of the advertisement.

7. The method of claim 5, wherein the probability of occurrence of the given user interaction when displaying the given portion of the advertisement is computed based on the number of on the nature of content included in the given portion of the advertisement.

8. The method of claim 7, wherein the probability of occurrence of the given user interaction when displaying the given portion of the advertisement is further computed based on the number of occurrences of the given user interaction when displaying the given portion of the advertisement.

9. An advertising server system for processing advertisements, the system comprising:
a processor;
a memory configured to store a set of instructions, which when executed by the processor cause the advertising server system to perform a method, the method including:
receiving, from an advertiser, the advertisement to be displayed in an advertising section of a publisher's webpage, the advertisement intended for display for a predefined duration of time within the advertising section;
partitioning the advertisement into a plurality of portions, the portions being of equal duration;
determining, for each of the portions, a cost for displaying a specific portion of the advertisement, the cost computed as a function of one or more user interactions with the specific portion of the advertisement; and
computing a total cost for displaying the advertisement, the total cost computed as a function of determined cost of displayed portions.

10. The system of claim 9, wherein a given cost incurred for displaying a given portion of the advertisement is further computed as a function of a cost-per-second (CPS) model of displaying the advertisement within the advertising section, the cost-per-second model indicative of total duration of display of the given portion of the advertisement within the advertising section.

11. The system of claim 10, wherein when the given cost incurred for displaying the given portion of the advertisement is computed as a function of both the cost-per-second (CPS) model and a given user interaction of the one or more user interactions with the given portion of the advertisement, the given cost is computed as an effective CPS (eCPS) value, the eCPS value being a function of a predetermined value associated with the given user interaction.

12. The system of claim 11, wherein the given user interaction includes one or more of:
a mouse roll-over over the advertisement;
a user click of the advertisement;
a rewinding of the advertisement;
a pausing of the advertisement;
a playing of the advertisement; or
a entering of information into one or more forms associated with the advertisement.

13. The system of claim 11, wherein the predetermined value associated with the given user interaction is computed as a function of both a preference score associated with the given user interaction and a probability of occurrence of the given user interaction when displaying the given portion of the advertisement.

14. The system of claim 13, wherein the preference score associated with the given user interaction is computed as a function of a desirability of the given user interaction to a given advertiser when displaying the given portion of the advertisement.

15. The system of claim 13, wherein the probability of occurrence of the given user interaction when displaying the given portion of the advertisement is computed based on the number of on the nature of content included in the given portion of the advertisement.

16. The system of claim 15, wherein the probability of occurrence of the given user interaction when displaying the given portion of the advertisement is further computed based on the number of occurrences of the given user interaction when displaying the given portion of the advertisement.

17. A method for processing and displaying an advertisement, the method comprising:
receiving, from an advertiser, by a platform server having a processor, the advertisement to be displayed in an advertising section of a publisher's webpage, the advertisement intended for display for a predefined duration of time within the advertising section;
partitioning, by the platform server, the advertisement into a plurality of segments, the segments being of equal duration;
determining, by the platform server, a cost for displaying a specific segment of the advertisement, the cost computed as an effective cost-per-second (eCPS) value, the eCPS value being a function of one or more predetermined values, wherein each of the one or more predetermined values is associated with a corresponding one of one or more user interactions with the specific segment of the advertisement; and
computing, by the platform server, a total cost for displaying the advertisement, the total cost computed as a function of determined cost of displayed segments, wherein the total cost for displaying the segments of the advertisement in the advertising section of the publisher's web page is assessed based on a cost-per-second (CPS) model.

18. The method of claim 17, wherein the CPS model indicative of total duration of display of the given segment of the advertisement within the advertising section.

19. The method of claim 17, wherein the given user interaction includes one or more of:
a mouse roll-over over the advertisement;
a user click of the advertisement;
a rewinding of the advertisement;
a pausing of the advertisement;
a playing of the advertisement; or
a entering of information into one or more forms associated with the advertisement.

20. The method of claim 17, wherein the predetermined value associated with the given user interaction is computed as a function of both a preference score associated with the given user interaction and a probability of occurrence of the given user interaction when displaying the given segment of the advertisement.

21. The method of claim 20, wherein the preference score associated with the given user interaction is computed as a function of a desirability of the given user interaction to a given advertiser when displaying the given segment of the advertisement.

22. The method of claim 20, wherein the probability of occurrence of the given user interaction when displaying the given segment of the advertisement is computed based on the number of on the nature of content included in the given segment of the advertisement.

23. The method of claim 22, wherein the probability of occurrence of the given user interaction when displaying the given segment of the advertisement is further computed based on the number of occurrences of the given user interaction when displaying the given segment of the advertisement.
